(19) United States
(12) Patent Application Publication
(10) Pub. No.: US 2026/0094161 A1
(43) Pub. Date: Apr. 2, 2026

(54) GROUP-BASED FRAUD DETECTION DECISIONING

(71) Applicant: Detective Analytics LLC, Toms River, NJ (US)

(72) Inventor: Dean Takacs, Toms River, NJ (US)

(73) Assignee: Detective Analytics LLC, Toms River, NJ (US)

(21) Appl. No.: 19/346,993

(22) Filed: Oct. 1, 2025

Related U.S. Application Data
(60) Provisional application No. 63/701,717, filed on Oct. 1, 2024.

(51) Int. Cl. G06Q 20/40; G06F 16/901

(52) U.S. Cl. CPC G06Q 20/4016; G06F 16/9024

(57) ABSTRACT

A computer system for detecting and assessing fraud risk employs group-based analysis to identify complex fraud patterns across various industries. The system identifies and analyzes groups of connected incidents by linking related events based on similarities in suspect identifiers, creating a network that reveals broader fraudulent behavior patterns. When processing a new incident, the system compares it against established groups of connected incidents, detecting subtle connections that may indicate relationships to known fraud patterns. This comparison can range from basic identifier matching to sophisticated analysis of multiple data points across different incidents within a group. Based on this comparison, the system generates a comprehensive fraud risk assessment for the new incident, leveraging collective information from grouped incidents to provide a nuanced and accurate evaluation of potential fraud risk. By considering new incidents in the context of established fraud patterns, the system offers insights not possible through individual incident analysis.

### CROSS-REFERENCE TO RELATED APPLICATIONS

This application claims the benefit of priority of U.S. Provisional Patent Application No. 63/701,717, filed Oct. 1, 2024, the contents of which are all incorporated herein by reference in their entirety.

### BACKGROUND

Fraud detection remains a critical challenge across various industries, including banking, e-commerce, and retail. As financial transactions and digital interactions continue to increase in volume and complexity, the need for effective fraud detection systems has become paramount. However, detecting fraudulent activities presents several significant challenges.

One of the primary difficulties in fraud detection is the dynamic nature of fraudulent tactics. Criminals continuously adapt their methods to circumvent existing security measures, making it challenging for traditional systems to keep pace with evolving fraud schemes. This constant evolution requires fraud detection systems to be highly adaptable and capable of identifying new patterns of suspicious activity.

Another challenge lies in the sheer volume of data that must be processed to effectively detect fraud. With millions of transactions occurring daily, fraud detection systems must be capable of analyzing vast amounts of information quickly and accurately. This high volume of data also increases the risk of false positives, where legitimate transactions are incorrectly flagged as fraudulent, potentially causing inconvenience to customers and unnecessary operational costs for businesses.

Traditional fraud detection systems often rely on analyzing individual incidents or transactions in isolation. This approach, while useful for identifying simple fraud patterns, has limitations when dealing with sophisticated, interconnected fraud schemes. By focusing on single events, these systems may miss important patterns that emerge only when multiple incidents are considered collectively.

Furthermore, existing systems frequently struggle with the identification and tracking of criminal networks. As fraudsters often work in groups or use multiple identities, detecting the full scope of their activities requires a more comprehensive approach than what traditional methods offer.

The limitations of current fraud detection methods also extend to their ability to make nuanced decisions about the legitimacy of transactions or incidents. Many systems rely on rigid rules or thresholds, which can be ineffective when dealing with complex fraud scenarios that require more complex decision-making processes.

In summary, the field of fraud detection faces significant challenges in adapting to evolving fraud tactics, processing large volumes of data, identifying complex fraud patterns, tracking criminal networks, and making nuanced decisions about potentially fraudulent activities. These limitations underscore the need for more advanced, flexible, and comprehensive fraud detection solutions that can address the sophisticated nature of modern fraudulent activities.

### SUMMARY

A computer system detects and assesses fraud risk in various industries, such as e-commerce, banking, and insurance. The system leverages the power of group-based analysis to identify complex fraud patterns that may go unnoticed by traditional fraud detection systems. The system identifies and analyzes groups of connected incidents, rather than examining each incident in isolation. By linking related incidents based on similarities in suspect identifiers, the system creates a network of interconnected events that reveals broader patterns of fraudulent behavior.

When a new incident occurs, the system compares the new incident against the established groups of connected incidents. This comparison goes beyond simple matching, allowing the system to detect subtle connections that might indicate a relationship to known fraud patterns. The system may employ various levels of complexity in this comparison, from basic identifier matching to sophisticated analysis of multiple data points across different incidents within a group.

Based on this comparison, the system generates a comprehensive fraud risk assessment for the new incident. This assessment leverages the collective information from the grouped incidents, providing a more nuanced and accurate evaluation of potential fraud risk. By considering the new incident in the context of established fraud patterns, the system can offer insights that would not be possible through individual incident analysis.

Other features and advantages of various aspects and embodiments of the present invention will become apparent from the following description and from the claims.

### BRIEF DESCRIPTION OF THE DRAWINGS

FIG. 1 is a dataflow diagram of a system for performing group-based fraud detection decisioning according to one embodiment of the present invention.

FIG. 2 is a flowchart of a method performed by the system of FIG. 1 according to one embodiment of the present invention.

FIG. 3 illustrates one of the plurality of groups of FIG. 1.

### DETAILED DESCRIPTION

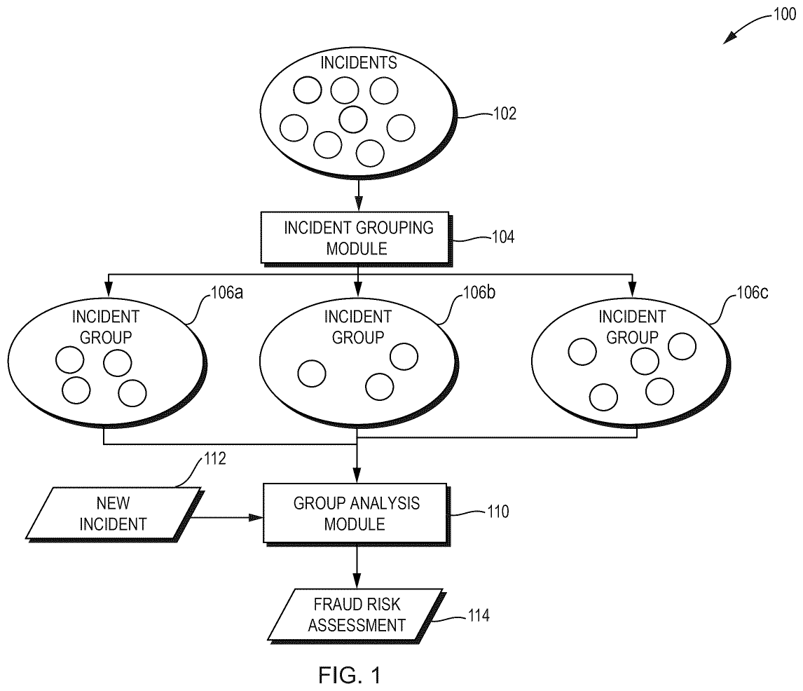

Embodiments of the present invention relate to the detection and analysis of incidents for purposes of fraud detection and/or prevention. In this context, an “incident” refers to any event, transaction, or occurrence that may be subject to fraud detection/prevention scrutiny. Referring to FIG. 1, a dataflow diagram is shown of a system 100 for performing group-based fraud detection decisioning according to one embodiment of the present invention.

Incidents form the fundamental units of analysis within the framework of embodiments of the present invention. The concept of incidents is introduced within the context of embodiments of the present invention to provide a standardized unit for data collection, analysis, and/or decision-making. By framing the fraud detection process around incidents, embodiments of the present invention may apply their group-based analysis techniques to a diverse range of scenarios across various industries, while maintaining a consistent approach to fraud detection. This incident-based framework allows embodiments of the present invention to process and analyze events in a uniform manner, regardless of their specific nature or the industry from which they originate. This uniformity assists in enabling embodiments of the present invention to link related incidents, form groups, and perform collective analysis to identify patterns of fraudulent behavior, as will be described in more detail below.

Incidents may encompass any of a variety of activities, including but not limited to financial transactions, account access attempts, retail refund claims, banking transactions, shoplifting reports, e-commerce purchases, insurance claims, point-of-sale transactions, customer service interactions, travel bookings, mobile app transactions, employee time and attendance records, social media activities, online gaming and gambling activities, loan applications, credit card applications, promotional offer redemptions, loyalty program activities, account registrations, password reset requests, wire transfers, check deposits, ATM withdrawals, cryptocurrency transactions, subscription sign-ups, product returns, warranty claims, medical claims, property damage claims, vehicle rental transactions, hotel reservations, flight bookings, ride-sharing requests, food delivery orders, online marketplace transactions, auction bids, digital wallet transactions, peer-to-peer payments, merchant account applications, business loan requests, investment account openings, tax filing submissions, government benefit applications, identity verification attempts, document uploads, profile updates, privacy setting changes, and/or any other actions that could potentially be associated with fraudulent behavior.

Embodiments of the present invention may be applied to a wide variety of incident types across different industries. The following are some non-limiting examples of incidents that may be analyzed using embodiments of the present invention:
Retail Refund Claims: These incidents involve customers requesting refunds for purchased items. Fraudulent refund claims might include returning stolen merchandise, making false claims about product defects, or attempting to return counterfeit goods.
Banking Transactions: Incidents in the banking sector could include various financial transactions such as withdrawals, deposits, transfers, or loan applications. Fraudulent banking incidents might involve unauthorized account access, identity theft, or money laundering attempts.
Shoplifting Reports: These incidents typically occur in retail environments and involve the theft of merchandise. Shoplifting incidents could range from individual thefts to organized retail crime operations.
E-commerce Purchases: Online shopping transactions can be considered incidents, with fraudulent activities potentially including the use of stolen credit card information, account takeovers, or the creation of fake buyer accounts.
Insurance Claims: Incidents in the insurance industry might include filing claims for various types of insurance (e.g., health, auto, property). Fraudulent insurance claims could involve staged accidents, exaggerated damages, or false medical claims.
Account Access Attempts: These incidents could occur across various platforms, including banking, social media, or corporate networks. Suspicious access attempts might indicate hacking efforts or unauthorized use of stolen credentials.
Point-of-Sale Transactions: In-store purchases using credit cards, debit cards, or mobile payment methods can be considered incidents. Fraudulent activities might include the use of skimming devices or counterfeit cards.
Customer Service Interactions: Incidents could include customer support calls, chat sessions, or email exchanges. Fraudulent activities in this context might involve social engineering attempts to gain unauthorized access to accounts or sensitive information.
Travel Bookings: Incidents in the travel industry could include flight reservations, hotel bookings, or car rentals. Fraudulent activities might involve the use of stolen loyalty points, credit card fraud, or identity theft.
Mobile App Transactions: Incidents could include in-app purchases, money transfers through mobile payment apps, or account registrations. Fraudulent activities might involve malware-infected apps, fake apps, or unauthorized access to mobile devices.
Employee Time and Attendance Records: In workforce management, each clock-in or clock-out event could be considered an incident. Fraudulent activities might include time theft or buddy punching.
Social Media Activities: Incidents on social media platforms could include post creations, friend requests, or account logins. Fraudulent activities might involve the creation of fake accounts, spreading of misinformation, or phishing attempts.

Multi-accounting fraud and e-commerce refund fraud are two examples of particularly useful types of incidents for embodiments of the present invention to analyze. Multi-accounting fraud encompasses various types of fraud involving individuals using different identifiers with multiple accounts to avoid detection. Examples include:
Online Gaming and Gambling: Fraudsters may engage in bonus abuse, match fixing, or collusion by creating multiple accounts with slightly varied personal information.
Social Media: Bad actors might create numerous accounts for engagement farming and content monetization, manipulating platform algorithms and advertising systems.
E-commerce and Marketing: Fraudulent users may generate fake reviews or manipulate seller ratings by using multiple accounts with different identifiers.
Financial Services: Individuals might abuse loan and credit systems by applying for multiple accounts using variations of their personal information.
Promo Abuse and Loyalty Fraud: Fraudsters may exploit promotional offers or loyalty programs by creating multiple accounts with slightly different identifiers.
E-commerce refund fraud specifically targets online retailers. Customers engaging in this fraud may make purchases and then claim they never received the shipment, demanding a refund. To avoid detection, these fraudsters often vary their identifiers across different orders or refund claims. For example, they might use slight variations in suspect identifiers such as email addresses, phone numbers shipping addresses, and personal names.

By being capable of analyzing such a diverse range of incidents, embodiments of the present invention demonstrate their versatility and applicability across multiple industries and scenarios. This broad scope enhances the potential of embodiments of the invention's potential for detecting various types of fraud and criminal activities.

An incident may be either a legitimate event or a criminal activity-the classification of an incident as fraudulent or legitimate is one of the outcomes of the analysis process performed by embodiments of the present invention. As this implies, an incident may lack any classification of “fraudulent,” “legitimate,” or otherwise before the incident is analyzed by embodiments of the present invention. Embodiments of the present invention may, for example, create groups of connected incidents before determining whether those incidents are fraudulent, and may apply fraud determinations after creating groups of connected incidents.

Any particular set of incidents that is processed by embodiments of the present invention may include only fraudulent incidents, only legitimate incidents, or (more commonly) a mix of both fraudulent and legitimate incidents. Incidents in a group of connected incidents may lack any classification, such as “fraudulent” or “legitimate,” at one time, and subsequently bear a classification, such as “fraudulent” or “legitimate,” at a later time, after embodiments of the present invention have performed any of the fraud detection techniques disclosed herein. The classification status of incidents may be dynamic and subject to revision as new information becomes available or as the system 100's analysis capabilities evolve.

An incident initially classified as legitimate may later be reclassified as fraudulent, or vice versa, based on subsequent analysis or the discovery of new connections to other incidents. Embodiments of the present invention may operate on incidents with varying degrees of certainty regarding their fraudulent or legitimate nature. Some incidents may have preliminary classifications with associated confidence scores, while others may remain completely unclassified throughout the analysis process. The system 100 may process incidents that have been pre-classified by other systems or human reviewers, and may either accept, modify, or override such pre-existing classifications based on group-based analysis.

In some cases, the system 100 may identify patterns that contradict initial classifications, leading to reclassification of incidents within a group. Groups of connected incidents may contain incidents with mixed classification statuses, including some that are classified as fraudulent, some as legitimate, some with uncertain status, and some that remain unclassified. This heterogeneous composition of groups may provide valuable insights for fraud detection analysis. The temporal aspect of incident classification may be significant, as incidents may transition through various classification states over time.

An incident may progress from unclassified to suspicious to fraudulent, or may follow other classification pathways as analysis proceeds and additional evidence becomes available. Embodiments of the present invention may generate fraud risk assessments and make fraud determinations independently of any pre-existing classifications, relying instead on the patterns and relationships discovered through group-based analysis. This approach may reveal fraudulent activities that were previously undetected or misclassified by other methods.

In embodiments of the present invention, incidents may be represented and stored within data structures designed to efficiently capture and organize the relevant information for fraud detection analysis. A single such data structure is referred to herein as an “incident data structure,” and a set of such data structures is referred to herein as “incident data.” Such data structures may, for example, be implemented as objects in an object-oriented programming language, records in a database system, or as vector/matrix representations, depending on the specific implementation requirements. In some cases, an incident may be stored as a high-dimensional vector (e.g., having at least 50 dimensions, at least 100 dimensions, at least 300 dimensions, at least 500 dimensions, at least 768 dimensions, or at least 1,000 dimensions), such as in a vector database, which enables efficient similarity searches and pattern recognition across large datasets of incidents 102.

The term “incident” may also be used herein to refer either to an incident data structure or to the real-world incident (e.g., insurance claim) that the incident data structure represents.

Embodiments of the system 100 may, for example, implement incident data structures using any one or more of the following approaches, in any combination: relational database tables with structured fields for suspect identifiers and incident metadata, NoSQL document stores such as MongoDB or CouchDB that store incident data as JSON or BSON documents, graph database structures where incidents are represented as nodes and relationships between incidents are represented as edges, time-series databases optimized for temporal analysis of incident patterns, distributed data structures across multiple computing nodes for handling large-scale incident processing, in-memory data structures such as hash tables or trees for rapid access during real-time fraud detection, blockchain-based immutable ledgers for maintaining tamper-proof incident records, columnar storage formats such as Apache Parquet for efficient analytical processing of incident data, key-value stores where incident identifiers serve as keys and incident details serve as values, vector databases that store high-dimensional vector representations of incidents for efficient similarity computations, and/or hybrid approaches that combine multiple storage mechanisms to optimize for different aspects of fraud detection processing.

A typical incident data structure may, for example, include any one or more of the following fields, in any combination: unique incident identifier, timestamp, location information, incident type (e.g., refund claim, banking transaction, shoplifting report), raw text description, array/list of suspect identifiers (which may include zero, one, or more suspect identifiers), additional metadata (e.g., transaction amount, product information), and vector/matrix representations of suspect identifiers, or any combination thereof. Any particular incident data structure may include zero, one, or more suspect identifiers. In some cases, the entire incident data structure may be transformed into a high-dimensional vector representation that encapsulates all relevant features of the incident, enabling the system 100 to perform rapid similarity comparisons and pattern matching operations.

Incident data structures used by embodiments of the present invention may, for example, be received from and/or generated based on data received from existing external systems associated with (e.g., received from) one or a plurality of organizations through various methods, such as any one or more of the following:
API Integration: Embodiments of the present invention may interface with external systems from one or a plurality of organizations (e.g., point-of-sale systems from various retailers, banking software from different financial institutions, e-commerce platforms from diverse online merchants) via APIs to receive incident data in real-time or in batches. Each organization may provide incident data through dedicated API endpoints that include organization-specific authentication and identification mechanisms.
Data Import: Incident data could be imported from external systems belonging to one or a plurality of organizations in standardized formats such as CSV, JSON, or XML. Each organization may provide data files through secure file transfer protocols, cloud storage systems, or dedicated data exchange platforms. Embodiments of the present invention may then parse this data to populate its internal incident data structures while preserving organizational attribution.
Database Synchronization: For systems with direct database access, embodiments of the present invention may synchronize with external databases from one or a plurality of organizations to pull incident data and convert it into the required internal data structures. This may involve connecting to databases from different organizations through secure network connections, virtual private networks, or cloud-based database services.
Event Streaming: In scenarios requiring real-time processing, embodiments of the present invention may consume incident data from event streaming platforms operated by or serving one or a plurality of organizations, converting each event into an incident data structure for immediate analysis. Organizations may publish incident events to shared streaming platforms or maintain separate streaming endpoints that the system monitors.
Web Scraping: For incidents reported on websites or public platforms associated with one or a plurality of organizations, embodiments of the present invention may employ web scraping techniques to extract relevant information and generate incident data structures. This may include monitoring multiple organizational websites, public reporting platforms, or industry-specific incident databases.
Multi-Tenant Data Feeds: Organizations may contribute incident data through multi-tenant platforms or shared service providers that aggregate data from one or a plurality of sources while maintaining organizational boundaries and access controls.
Industry Consortiums: Organizations within specific industries may participate in data sharing consortiums or collaborative fraud prevention networks where incident data is shared among member organizations for collective fraud detection purposes.

The incident data received from one or a plurality of organizations may indicate the corresponding organizations of origin through various mechanisms, such as any one or more of the following: organizational metadata fields that explicitly identify the contributing organization, tenant tags or identifiers that map to specific organizations in a multi-tenant system, API keys or authentication tokens that are organization-specific, database schema prefixes or table naming conventions that indicate organizational ownership, organizational identifiers embedded within the incident data structure itself, source system identifiers that correspond to specific organizational systems, network routing information that indicates the originating organization's infrastructure, digital signatures or certificates that authenticate the organizational source, organizational domain names or URLs associated with the incident data, and/or industry-specific organization codes or identifiers that conform to established standards. In this context, an incident being “associated with” an organization may mean, for example, that the incident was received from the organization and/or that the incident contains data (such as metadata) identifying the organization as the source of the incident.

Once the incident data is received or generated from one or a plurality of organizations, embodiments of the invention may process this information to extract and standardize suspect identifiers, linking related incidents based on these identifiers to form groups for further analysis while maintaining organizational attribution and access controls, as will be described in more detail below. It is important to note that the specific implementations of incident data structures described above are merely examples, and that embodiments of the present invention are not limited to use with incident data structures implemented in the ways disclosed herein.

Within the context of embodiments of the present invention, a “suspect identifier” refers to data that may be used to potentially link or associate different incidents. Suspect identifiers play a valuable role in the ability of embodiments of the present invention to form groups of related incidents for analysis and fraud detection.

Suspect identifiers may include one or more data points. Some non-limiting examples include:
Personal Information, such as full name, email address, phone number, physical address, Social Security Number
Financial Information, such as credit card number, bank account number, custom loyalty number, unique customer ID
Biometric data, such as fingerprint, retinal scan, face map, unique physical gait map
Digital identifiers, such as IP address, device ID, input device (e.g., keyboard or mouse) usage pattern
Physical descriptors, such as height, weight, eye color, hair color, ethnicity, distinctive physical characteristics (e.g., tattoos, scars)
Vehicle Information, such as license plate number, vehicle make and model
Government-issued identifiers, such as driver's license number, passport number

Any analysis that is described herein as being performed based on a suspect identifier may be performed based on one or more suspect identifiers of the same type and/or different types, in any combination. For example, such analysis may be based on multiple email addresses, whether associated with the same people or different people. As another example, such analysis may be based on one or more full names, one or more email addresses, and one or more credit card numbers, associated with the same person or different people.

Suspect identifiers may serve any of a variety of purposes within embodiments of the present invention such as any one or more of the following:
Incident Linking: Suspect identifiers serve as the primary means of establishing connections between different incidents. Embodiments of the present invention use these identifiers to recognize when multiple incidents may involve the same individual or group, even if other details of the incidents vary.
Group Formation: By identifying similarities or exact matches in suspect identifiers across multiple incidents, embodiments of the present invention may form groups of related incidents. These groups become the basis for more comprehensive fraud analysis.
Pattern Recognition: The presence and variation of suspect identifiers across grouped incidents can reveal patterns indicative of fraudulent behavior. For example, slight variations in email addresses or phone numbers across multiple incidents might suggest a deliberate attempt to avoid detection.
Adaptive Learning: As the system encounters new incidents and identifier variations, it can learn and adapt its linking and analysis processes. This allows embodiments of the present invention to keep pace with evolving fraud tactics.
Criminal Network Tracking: By analyzing the relationships between different suspect identifiers across grouped incidents, embodiments of the present invention can potentially uncover and track the activities of larger criminal networks.

As will be described in more detail below, embodiments of the invention may be designed to recognize and link not just exact matches of suspect identifiers, but also variations that might indicate an attempt to obfuscate connections between incidents. This capability enhances the effectiveness of embodiments of the present invention in detecting sophisticated fraud schemes.

The suspect identifiers within each incident data structure may be stored in any of a variety of forms, such as any one or more of the following, in any combination: nested data structures that organize identifiers hierarchically by type and priority, arrays or lists that maintain identifiers in sequential order, hash tables or dictionaries that provide key-value mappings for rapid identifier lookup, tree structures that enable efficient searching and sorting of identifiers, linked lists that allow dynamic addition and removal of identifiers, relational database records with structured fields for different identifier types, JSON or XML documents that provide flexible schema for varying identifier formats, binary encoded formats that optimize storage space and access speed, compressed data structures that reduce memory footprint while maintaining accessibility, encrypted storage formats that protect sensitive identifier information, distributed data structures that span multiple storage nodes for scalability, time-series data structures that capture identifier changes over time, graph-based structures that represent relationships between different identifiers, columnar storage formats optimized for analytical processing, key-value stores where identifier types serve as keys, blockchain-based immutable records for tamper-proof identifier storage, in-memory caches for high-speed identifier retrieval, vector/matrix embeddings that represent identifiers as numeric arrays for machine learning applications, sparse matrices that efficiently handle identifiers with many null values, and/or hybrid approaches that combine multiple storage mechanisms to optimize for different aspects of identifier processing and analysis.

Vector/matrix embeddings may include, but are not limited to, facial recognition embeddings, gait recognition embeddings, text embeddings, or combinations of multiple suspect identifiers transformed into a single embedding representation. Although the term “vector representation” may be used herein for ease of explanation, any such reference to a “vector representation” should be understood to be applicable to a vector representation and/or a matrix representation.

Suspect identifiers may be transformed into, or natively stored in, numeric vector and/or matrix embedding representations. This transformation allows for more sophisticated and efficient comparison of identifiers across incidents. Although the term “vector embeddings” may be used herein for ease of explanation, any such reference to “vector embeddings” should be understood to be applicable to vector embeddings and/or matrix embeddings.

As some examples, suspect identifiers may be stored in and/or transformed into any one or more of the following: text embeddings (e.g., for names, addresses, and other textual identifiers), facial recognition embeddings, and gait recognition embeddings.

Converting or otherwise storing suspect identifiers in vector embeddings offers several benefits. For example, vector representations can embed identifiers in a way that captures both nickname variations and misspellings. For example, “Michael Jones” may be represented close to both “Mike Jones” and “Michael Joens” in the vector space. By converting identifiers to numeric vectors, the system 100 may perform rapid similarity calculations using vector algebra techniques. Two or more suspect identifiers (e.g., personal name and street address) may be converted into a single embedding representation. This combined embedding contains more unique information about an individual than separate representations for each identifier.

The vector embedding approach also allows the system 100 to incorporate non-suspect identifier data to enhance the system 100's ability to detect connections between incidents. For example, the system 100 may combine one or more suspect identifiers associated with an incident with geographical and temporal data associated with the incident. This allows the system 100 to represent, for example, a person's name alongside where and when they were detected, providing a more comprehensive identifier. As another example, the system 100 may create embedding representations for larger subsets of each incident, encompassing one or more suspect identifiers along with some or all non-suspect identifier data (such as date and time of incident, products affected, or location information). By incorporating these vector/matrix representation techniques, the system 100 may perform more nuanced and efficient similarity comparisons, enhancing its ability to detect complex fraud patterns across incidents.

Although some embodiments of the system 100 compare suspect identifiers (e.g., in the new incident and existing incidents), it is important to note that some embodiments of the system 100 may determine matches between incidents based solely on non-suspect identifier information, such as geographical information and/or temporal information related to new and existing incidents. Additional examples of non-suspect identifier information may include, for example, transaction amounts, product categories, payment methods, device fingerprints, network characteristics, behavioral patterns, session durations, and/or user interaction sequences. This capability allows the system 100 to identify potential connections even when, for example, traditional suspect identifiers are not available or applicable.

For example, the system 100 may compare geographical and temporal data between incidents (e.g., a new incident and existing incidents) to identify patterns or clusters of activity. This may, for example, involve analyzing the location and timing of events, the types of products or services involved, and/or other contextual information that is not directly tied to a suspect's identity. By incorporating this capability, the system 100 maintains its flexibility and effectiveness in scenarios where traditional suspect identifiers may be limited or unavailable, further enhancing its overall fraud detection capabilities.

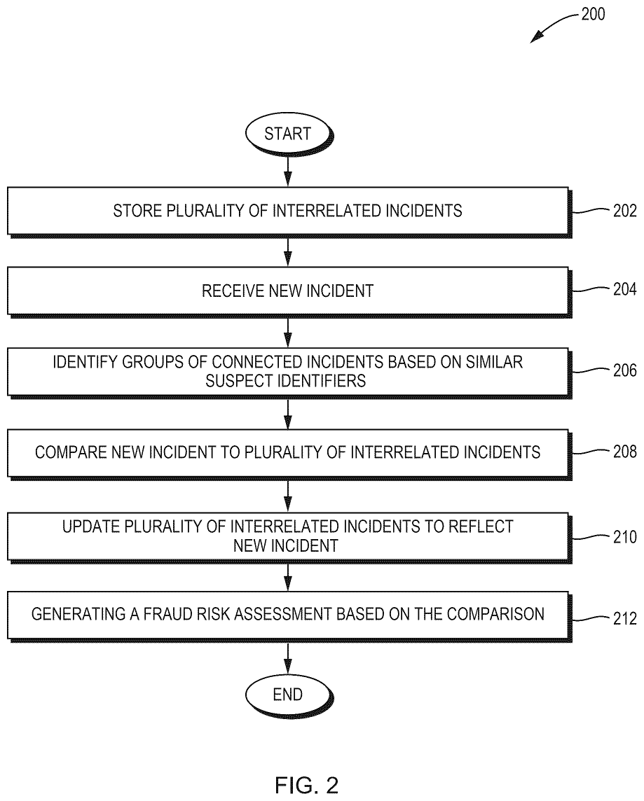

Referring to FIG. 2, a flowchart is shown of a method 200 performed by the system 100 according to one embodiment of the present invention.

The system 100 includes a plurality of incidents 102, which may be a plurality of incident data structures of the kind described above and elsewhere herein. The particular number of incidents 102 shown in FIG. 1 is merely a small number shown for ease of illustration. In practice, the incidents 102 may include any number of incidents. In many practical situations, this number is in the many thousands or greater. As some examples, the number of incidents 102 may be at least 1,000, at least 10,000, at least 100,000, at least 1 million, at least 10 million, or at least 100 million.

The method 200 stores the plurality of interrelated incidents 102 with associated connection data that indicates relationships between incidents based on similarities in suspect identifiers, wherein the plurality of interrelated incidents 102 may be associated with one or a plurality of organizations (FIG. 2, operation 202). The incident grouping module 104 receives the incidents 102 as input and analyzes the suspect identifiers associated with each incident to establish connections between related incidents. This process involves extracting suspect identifiers from each incident's data structure, comparing these identifiers across all incidents 102 to identify similarities or exact matches, and creating connection data that represents the relationships discovered through this analysis. The connection data may indicate relationships implicitly rather than through explicit storage of relationship information, such that the relationships between incidents may only become explicitly identified during subsequent processing operations. In some embodiments, the plurality of interrelated incidents 102 may be received from or otherwise associated with one or a plurality of organizations, such as different retailers, financial institutions, insurance companies, and/or other entities that contribute incident data to the system 100 for collective fraud detection analysis.

The connection data may be stored in various forms depending on the specific implementation. Examples include relational database records that link incident identifiers through foreign key relationships, graph database structures where incidents serve as nodes and connections serve as edges, or vector database indices that enable efficient similarity searches. The connection data may include metadata about the strength or confidence level of each connection, such as similarity scores that quantify how closely related two incidents are based on their suspect identifiers. In some implementations, relationships are indicated through implicit means, such as storing incidents with similar suspect identifiers in proximity within a data structure, where the relationships are derived through analysis of the stored data patterns rather than being explicitly recorded. The system 100 may maintain organizational attribution for each incident within the connection data, enabling the system 100 to track which organizations contributed specific incidents while still allowing cross-organizational pattern detection and analysis.

The storage process creates bidirectional links between related incidents 102, allowing the system 100 to traverse connections in either direction during subsequent analysis. For incidents that share multiple suspect identifiers, the connection data captures information about each type of identifier match, enabling more nuanced analysis of the relationships. The system 100 stores this connection data in a format that supports efficient querying and updating as new incidents are processed and additional connections are discovered. The indication of relationships may be achieved through data organization techniques where related incidents are grouped or clustered based on suspect identifier similarities, with the actual relationship connections being determined dynamically during analysis rather than being pre-stored as explicit relationship records. In some cases, the connection data may preserve organizational boundaries while enabling cross-organizational fraud pattern detection, such that incidents from different organizations may be linked based on suspect identifier similarities while maintaining appropriate data governance and access controls.

During operation 202, the system 100 employs various techniques to optimize the storage and organization of the connection data. These include indexing strategies that enable rapid retrieval of all incidents connected to a particular incident, and clustering techniques that group related connection data together for improved performance. The storage process includes validation steps to ensure the integrity and consistency of the connection data, such as verifying that all referenced incidents exist and that connection strengths fall within expected ranges. The connection data provides the foundation for relationship identification without explicitly defining each relationship, such that the relationships between incidents emerge through computational analysis of the stored suspect identifier patterns and similarities.

In some embodiments, storing the plurality of interrelated incidents 102 comprises training a neural network to generate vector embeddings of incident data. The incident grouping module 104 implements neural network training processes that learn to represent incident data as high-dimensional vectors in a vector space. The neural network training process maps incident data from incidents within a same group of the plurality of groups 106a-c to closer positions within the vector space, while simultaneously mapping incident data from incidents in different groups to more distant positions within the vector space. This training approach enables the neural network to learn representations where incidents that share similar suspect identifiers or belong to the same fraud patterns are positioned near each other in the vector space, while incidents from different fraud patterns or unrelated legitimate activities are positioned farther apart. The neural network training may incorporate organizational information as additional features, enabling the system 100 to learn patterns that span multiple organizations while respecting organizational boundaries where appropriate.

The neural network training process utilizes various machine learning techniques to optimize the vector embeddings for fraud detection purposes. The system 100 may employ contrastive learning methods that explicitly minimize distances between incident vectors within the same group while maximizing distances between incident vectors from different groups. The training process may incorporate supervised learning approaches where known fraud labels guide the positioning of incident vectors in the embedding space, or unsupervised learning methods that discover natural clustering patterns based solely on suspect identifier similarities. The resulting vector embeddings are stored as part of the incidents 102 data structures, enabling the incident grouping module 104 and group analysis module 110 to perform efficient similarity computations and pattern recognition operations during fraud detection analysis. The training process may account for the multi-organizational nature of the data by learning representations that capture fraud patterns that may manifest differently across different organizational contexts or industries.

The neural network architecture used for generating vector embeddings may include feedforward networks, recurrent neural networks, transformer architectures, and/or convolutional neural networks, depending on the characteristics of the incident data being processed. The training process involves iterative optimization procedures where the neural network parameters are adjusted to improve the quality of the vector embeddings based on feedback from the grouping accuracy and fraud detection performance. The neural network may be trained using multi-task learning approaches that simultaneously optimize for multiple objectives, such as accurate incident grouping, fraud pattern recognition, and computational efficiency. The vector embeddings generated through this neural network training process provide a foundation for all subsequent operations in the method 200, including the identification of groups of connected incidents in operation 206 and the comparison of new incidents against existing groups in operation 208. The training process may incorporate domain adaptation techniques to ensure that the learned representations generalize effectively across the different organizational contexts and data formats present in the multi-organizational incident dataset.

The system 100 may receive and/or generate a new incident 112 (FIG. 2, operation 204). The new incident 112 may, for example, be an incident data structure that represents a fresh occurrence or event that the system 100 needs to evaluate for potential fraudulent activity. The new incident may arise from various situations, such as a new refund claim submitted by a customer in an e-commerce context, a recent banking transaction or account access attempt, a newly reported case of shoplifting or retail theft, a recent e-commerce purchase transaction, or any other type of new incident of any kind disclosed herein. Note that the new incident 112 may be “new” in the sense that it is newly generated and/or received by the system 100, whether or not it represents an event that has recently occurred. For example, the new incident 112 may represent an incident that occurred before the plurality of groups 106a-c were generated, but still be a “new” incident in the sense disclosed herein because the new incident 112 is being newly processed by the group analysis module 110.

The system 100 may receive and/or generate the new incident 112 through any of a variety of methods, such as any one or more of the following:
API Integration: The system 100 may receive real-time data about new incidents through one or more APIs connected to external systems like point-of-sale platforms, banking software, or e-commerce websites.
Data Import: New incident data may be imported into the system 100 in one or more standardized formats (e.g., CSV, JSON, XML) from one or more external sources.
Database Synchronization: The system 100 may synchronize with external databases to pull in new incident data as it occurs.
Event Streaming: In scenarios requiring real-time processing, the system 100 may consume new incident data from event streaming platforms.
Web Scraping: For incidents reported on websites or public platforms, the system 100 may employ web scraping techniques to extract relevant information about new incidents.

The system 100 includes an incident grouping module 104, which receives the incidents 102 as input, and identifies, based on data in the incidents 102, a plurality of groups 106a-c of connected incidents from the plurality of interrelated incidents 102 (FIG. 2, operation 206). The data in the incidents 102 may include, for example, connection data and/or any other data in the incidents 102. Each group in the plurality of groups 106a-c may comprise a corresponding plurality of incidents connected based on similarities in suspect identifiers.

Each of the groups 106a-c may contain incidents from one or more of a plurality of organizations, enabling cross-organizational fraud pattern detection and analysis. In some embodiments, each of the groups 106a-c contains a plurality of incidents from at least two organizations, allowing the system 100 to identify fraud patterns that span multiple organizational boundaries and may not be apparent when analyzing incidents from individual organizations in isolation.

During the identification process, the incident grouping module 104 may generate data structures representing the plurality of groups 106a-c, where each data structure contains references to the incidents that belong to the corresponding group. This process may, for example, involve: extracting suspect identifiers from each incident's data structure, comparing these identifiers across all incidents to identify similarities or exact matches, linking incidents that share common or similar suspect identifiers, forming groups based on these linked incidents, and creating data structures that represent the identified groups.

The incident grouping module 104 may employ various approaches to identify the plurality of groups 106a-c, ranging from traditional similarity-based methods to advanced machine learning and vector embedding techniques. These approaches may be implemented individually or in combination to achieve optimal grouping results.

The incident grouping module 104 may employ vector embedding approaches for grouping incidents based on suspect identifiers. In such embodiments, suspect identifiers may be transformed into high-dimensional vector representations that capture semantic and structural similarities between identifiers. Various embedding techniques, such as Word2Vec, FastText, or transformer-based embeddings, may convert textual suspect identifiers into numeric vectors. These vector representations may enable identification of subtle relationships between identifiers that may not be apparent through traditional string matching techniques. For example, variations in names like “Michael” and “Mike” or slight misspellings may be represented as nearby points in the vector space, allowing recognition of these as potentially related identifiers.

In some embodiments, the incident grouping module 104 may utilize graph-based structures to represent and analyze relationships between incidents. A graph may be constructed where incidents serve as nodes and edges represent connections based on shared or similar suspect identifiers. Each edge may be weighted according to the strength of the relationship between connected incidents, such as the degree of similarity between their suspect identifiers or the number of shared identifiers. Graph-based approaches may enable capture of complex, multi-hop relationships between incidents that may not be directly connected but are related through intermediate incidents. Graph traversal algorithms may explore neighborhoods around specific incidents and identify all incidents within a certain distance or connectivity threshold.

The incident grouping module 104 may implement various clustering and machine learning techniques to automatically discover patterns and groupings within the incident data. These approaches may include unsupervised learning algorithms such as k-means clustering, hierarchical clustering, density-based clustering algorithms (such as DBSCAN), Gaussian mixture models, or self-organizing maps. Vector representations may undergo clustering operations using these techniques to form groups of related incidents. Graph-based clustering algorithms, such as community detection methods, modularity optimization, or spectral clustering, may identify densely connected subgraphs that represent groups of related incidents. Models may be trained on features derived from suspect identifiers, such as character n-grams, phonetic representations, or statistical properties of the identifiers. In some cases, semi-supervised learning approaches may leverage both labeled and unlabeled incident data to improve grouping accuracy. Ensemble methods may combine multiple clustering algorithms to achieve more robust and stable grouping results. These machine learning approaches may enable adaptation to evolving fraud patterns and automatically adjust grouping criteria based on observed data characteristics.

The incident grouping module 104 may implement probabilistic grouping approaches that assign confidence scores or probabilities to group memberships rather than making binary grouping decisions. These approaches may model the uncertainty inherent in grouping decisions and provide probabilistic assessments of whether incidents belong to specific groups. Bayesian methods, probabilistic graphical models, or fuzzy clustering techniques may generate probabilistic group assignments. Each incident may be assigned membership probabilities for multiple groups, allowing capture of cases where incidents may legitimately belong to multiple groups or where group membership is uncertain. These probabilities may be propagated through subsequent analysis stages, enabling downstream components to make more informed decisions based on the uncertainty in grouping results. Probabilistic approaches may also enable incorporation of prior knowledge about fraud patterns or domain-specific constraints into the grouping process.

The incident grouping module 104 may implement dynamic threshold adjustment methods to optimize the grouping process based on data characteristics and performance metrics. Rather than using fixed similarity thresholds, these thresholds may be automatically adjusted based on factors such as the distribution of similarity scores, the size of resulting groups, or validation metrics. Adaptive algorithms may monitor grouping quality and iteratively refine threshold values to achieve desired clustering properties. For example, similarity thresholds may increase when groups become too large or decrease when too many incidents remain ungrouped. Different threshold values may be implemented for different types of suspect identifiers, recognizing that some identifier types may require stricter or more lenient matching criteria. These dynamic approaches may enable maintenance of consistent grouping quality across diverse datasets and evolving fraud patterns.

In various embodiments, the incident grouping module 104 may employ multi-stage grouping processes that apply different techniques in sequence or combination. An initial grouping stage may use computationally efficient methods, such as exact string matching or simple similarity metrics, to identify obvious connections between incidents. Subsequent stages may apply more sophisticated techniques, such as fuzzy matching algorithms or machine learning models, to identify subtler relationships. Hierarchical grouping approaches may create multiple levels of granularity, from fine-grained groups based on strict similarity criteria to coarser groups that capture broader patterns. Each stage may refine or merge groups from previous stages, allowing balance between computational efficiency and grouping accuracy. Different validation criteria may be applied at each stage to ensure that grouping quality is maintained throughout the multi-stage process.

In some embodiments, the incident grouping module 104 may employ hybrid methodologies that combine multiple grouping techniques to leverage the strengths of different approaches. Rule-based methods may be integrated with machine learning algorithms, combining the interpretability and domain knowledge of rule-based approaches with the adaptability and pattern recognition capabilities of machine learning. Different similarity metrics or distance functions may be combined, using ensemble methods to aggregate results from multiple similarity measures. Hybrid approaches may include voting mechanisms where multiple grouping algorithms contribute to final grouping decisions, or weighted combination schemes that assign different importance to different techniques based on their performance or reliability. Different techniques may be dynamically selected or weighted based on characteristics of the input data, such as data quality, volume, or the types of suspect identifiers present. These hybrid methodologies may provide more robust and accurate grouping results than any single technique alone.

The incident grouping module 104 may incorporate temporal and geographical factors into the grouping process to enhance the identification of related incidents. Temporal grouping factors may include the timing of incidents, patterns in incident occurrence over time, or seasonal variations in fraudulent activity. Connections between incidents may be weighted based on their temporal proximity, giving higher weights to incidents that occur within similar time windows. Geographical grouping factors may include the physical locations associated with incidents, such as shipping addresses, IP address locations, or transaction locations. Geographical clustering techniques may identify incidents that occur within specific geographic regions or that follow geographic patterns indicative of coordinated fraudulent activity. Temporal and geographical factors may be combined with suspect identifier similarities to create more comprehensive grouping criteria that capture both identity-based and contextual relationships between incidents.

In some embodiments, the incident grouping module 104 may employ Large Language Models as part of the grouping refinement process. This approach may involve providing data from a selected group of the plurality of groups as input to a Large Language Model, which may then generate at least one subgroup from within the selected group based on the provided data. The Large Language Model may analyze the semantic relationships and patterns within the group data to identify more nuanced subdivisions that may not be apparent through traditional clustering methods. This LLM-based refinement may enable the system to create more precise groupings by leveraging the advanced pattern recognition and contextual understanding capabilities of large language models.

The plurality of groups 106a-c may represent clusters of incidents that are actually and/or potentially related through common identifiers or their variations. Each group may contain incidents that share one or more similar suspect identifiers, suggesting a possible connection between the incidents within that group. Although a group may, and often will, contain a plurality of incidents, a group may include only a single incident. The incident grouping module 104 may generate data representations for each identified group, which may include metadata about the group such as the total number of incidents, the types of connections between incidents, and summary information about the suspect identifiers present within the group. In some embodiments, the incident grouping module 104 may determine whether to include a set of connected incidents as one of the plurality of groups based on a count of non-fraudulent incidents within the set of connected incidents, allowing the system to filter or prioritize groups based on their composition of legitimate versus potentially fraudulent activities.

Each of the incidents 102 may belong to zero of the plurality of groups 106a-c, exactly one of the plurality of groups 106a-c, or a plurality of the plurality of groups 106a-c. As this implies, one or more of the incidents 102 may belong to multiple ones of the plurality of groups 106a-c, such as if they share identifiers with incidents in different groups. As will be described in more detail below, the plurality of groups 106a-c serve as a foundation for further analysis, allowing the system 100 to identify patterns and anomalies that may indicate fraudulent behavior across related incidents.

The particular number of groups 106a-c, and the particular numbers of incidents within the groups 106a-c, shown in FIG. 1 are merely small numbers shown for ease of illustration. In practice, the system 100 may identify any number of groups 106a-c, each of which may include any number of incidents. The incident grouping module 104 may generate corresponding data structures to represent each identified group, enabling efficient storage and retrieval of group information.

The incident grouping module 104 may perform the grouping of the incidents 102 into the plurality of groups 106a-c using, for example, the techniques described in U.S. patent application Ser. No. 16/205,104, entitled “Method for Automatically Linking Associated Incidents Related to Criminal Activity,” filed on Nov. 29, 2018. Embodiments of the present invention, however, are not limited to grouping the incidents 102 or otherwise generating the plurality of groups 106a-c using the techniques disclosed in U.S. patent application Ser. No. 16/205,104, which is merely one example of techniques that may be used by embodiments of the present invention to generate the plurality of groups 106a-c. The incident grouping module 104 may implement any combination of the grouping approaches described herein, including vector embedding methods, graph-based clustering, machine learning techniques, dynamic threshold adjustment, multi-stage processing, temporal and geographical analysis, probabilistic modeling, and hybrid methodologies. The selection of specific grouping techniques may depend on factors such as the characteristics of the incident data, computational resources, accuracy requirements, and the specific fraud detection objectives of the system 100.

The incident grouping module 104 may refine one or more of the plurality of groups 106a-c to improve the accuracy and reliability of the groupings. This refinement process may address situations where certain suspect identifiers create spurious connections between incidents that may not represent genuine relationships. For example, common email domains, generic phone area codes, or frequently occurring names may create connections between incidents that are not meaningfully related. The refinement process may occur as part of operation 206 of the method 200 (FIG. 2), where the incident grouping module 104 identifies the plurality of groups 106a-c of connected incidents from the plurality of interrelated incidents 102. In some embodiments, the refinement may be performed iteratively during operation 206, allowing the incident grouping module 104 to continuously improve the quality of the plurality of groups 106a-c before the group analysis module 110 performs the comparison in operation 208. The group refinement may, for example, be performed before generating any fraud risk assessment 114 in operation 212.

Referring to FIG. 1, the incident grouping module 104 may evaluate whether a selected group from the plurality of groups 106a-c is over-connected due to one or more problematic suspect identifiers that create spurious connections between incidents. This evaluation may include designating at least one always-link identifier that maintains connections between incidents regardless of the refining process, and may include designating at least one never-link identifier that is prevented from creating connections between incidents during the refining process. The incident grouping module 104 may break the connections associated with the identified problematic suspect identifiers, effectively splitting the selected group into two or more candidate subgroups. For example, if a particular email domain is identified as problematic, the incident grouping module 104 may separate incidents connected solely by that domain into different candidate subgroups. This separation allows the incident grouping module 104 to evaluate whether other suspect identifiers support maintaining these connections, providing a more accurate assessment of genuine relationships between incidents.

After creating the candidate subgroups, the incident grouping module 104 may approve at least one of the candidate subgroups as a verified group through a verification and approval process, thereby defining a set of verified groups. This approval process may be performed by: (1) one or more human reviewers who manually evaluate the candidate subgroups and approve those that demonstrate genuine relationships between incidents; and/or (2) one or more automated processes, such as a machine-learned verifier, which may include a language model (e.g., a Large Language Model or LLM). In cases where automated verification is employed, the incident grouping module 104 may utilize one or more Large Language Models as part of the verification process to analyze the relationships between candidate subgroups, where these models may consider the semantic context and patterns within the suspect identifiers to generate more nuanced similarity assessments and make approval determinations. The incident grouping module 104 may then designate the at least one approved subgroup as a verified group within the plurality of groups 106a-c. The refinement process may be applied recursively to the resulting candidate subgroups, where after splitting a group and approving the initial candidate subgroups as verified groups, the incident grouping module 104 may apply the same process to each verified subgroup, potentially identifying additional problematic identifiers and creating further subdivisions. This recursive refinement may continue until no further meaningful splits are identified or until certain stopping criteria are met.

The incident grouping module 104 may designate certain suspect identifiers as “always-link” identifiers that maintain connections between incidents regardless of the refinement process. For example, certain high-confidence identifiers like verified government ID numbers or biometric data may be designated as always-link identifiers. Conversely, the incident grouping module 104 may designate other suspect identifiers as “never-link” identifiers that are prevented from creating connections between incidents during the refinement process, where these may include identifiers known to create spurious connections or those with low reliability. The incident grouping module 104 may also incorporate manual refinements into the approval process, where one or more human reviewers may manually evaluate and approve specific candidate subgroups as verified groups, or may manually break specific connections between suspect identifiers and incidents. The incident grouping module 104 may store these manual approvals and breaks and apply them in future processing iterations, ensuring that manually approved verified groups are preserved and that manually identified false connections are not recreated during subsequent refinement processes.

After completing the refinement and approval process, the resulting verified groups become part of the plurality of groups 106a-c used by the group analysis module 110 for comparing against new incidents 112. This refinement and verification process may help ensure that the groups used for fraud detection more accurately represent genuine relationships between incidents, potentially improving the accuracy of subsequent fraud risk assessments 114 generated by the group analysis module 110. With continued reference to FIG. 1, the verified plurality of groups 106a-c may provide a more reliable foundation for the group analysis module 110 to perform the comparison operations described in operation 208 of the method 200 (FIG. 2). The refinement and approval process may enhance the overall effectiveness of the system 100 by reducing false positive connections while preserving meaningful relationships between related incidents 102, with the set of verified groups serving as a curated collection of high-quality incident groupings for fraud detection analysis.

Consider a particular example that will be referred to herein as Example A, in which embodiments of the system 100 of FIG. 1 may be applied to detect fraud in the context of e-commerce refund claims. In this example, the incidents 102 represent millions of refund claims from a large online clothing retailer. Each claim is created when a customer reports that they paid for an order but never received the shipment. These refund claim incidents 102 contain various suspect identifiers, including the customer's full name, shipping address, email address, phone number, and a hashed credit card number. While most of these claims may be legitimate, some are likely to be fraudulent attempts to obtain free merchandise.

The incident grouping module 104 processes these refund claim incidents 102 by analyzing the suspect identifiers associated with each claim and creates links between incidents based on the similarity of these identifiers. For example, the incident grouping module 104 may link claims that use slightly different variations of names, email addresses, phone numbers, and/or shipping addresses, which could indicate attempts by fraudsters to avoid detection as repeat claimants. From these links, the incident grouping module 104 forms connected groups of incidents, stored as the plurality of groups 106a-c. Each group represents a set of refund claims that are potentially related through common and/or similar suspect identifiers, while some incidents may have no links to other incidents and will be stored as singleton groups.

After processing the millions of refund claim incidents 102, the incident grouping module 104 may identify thousands of connected groups within the plurality of groups 106a-c. These groups represent various patterns of linked incidents based on similar suspect identifiers. Some of these groups might consist of legitimate customers who have experienced multiple genuine delivery issues, while other groups may reveal patterns indicative of potential fraudulent activity. For instance, a group within the plurality of groups 106a-c may contain incidents where a suspected fraudster has used different variations of email addresses following a pattern, such as “basketballmike123@gmail.com”, “basketballmike124@gmail.com”, and “basketballmichael242@gmail.com”. Despite using these similar email addresses, the associated names, phone numbers, and shipping addresses for these incidents (e.g., claim numbers 43450, 43451, and 43452) might be completely different.

The incident grouping module 104 may also identify more complex interconnections that span multiple types of suspect identifiers. For example, incident 43453 with the email “basketballmike125@gmail.com” might be linked to a shipping address “123 Main St, Springfield, NJ” that is also associated with five other incidents. One of those five incidents might share a phone number (555-123-4567) with eight additional incidents, creating a web of interconnected relationships that would be difficult to detect through traditional fraud detection methods that examine incidents in isolation. As a result of this grouping process, the plurality of groups 106a-c may contain thousands of large interconnected groups of incidents, each connected based on either identical suspect identifiers and/or very similar suspect identifiers. These groups form the foundation for further analysis by the system 100, enabling the system 100 to identify patterns and anomalies that may indicate fraudulent behavior across related incidents.

Embodiments of the system 100 may identify connections among incidents and create incident groups based on non-suspect identifier information. This non-suspect identifier information may be used either as an alternative to or in conjunction with suspect identifiers. Non-suspect identifier information may include, but is not limited to, any one or more of the following: geographical data (e.g., location of incidents), temporal data (e.g., date and time of incidents), product or service information related to the incidents, transaction details (e.g., amount, method of payment), and device or network information associated with the incidents.

The system 100 may analyze this non-suspect identifier information to detect patterns, clusters, or similarities among incidents that may not be apparent when focusing solely on suspect identifiers. For example, the system 100 may identify a group of incidents that occurred within a specific geographic area and timeframe, even if no common suspect identifiers are present.

To facilitate efficient comparison and pattern recognition, the system 100 may employ any of the techniques disclosed herein, such as vector embeddings, to represent non-suspect identifier information. This approach enables the detection of subtle connections between incidents and allows for the creation of more comprehensive and nuanced incident groups.

By incorporating non-suspect identifier information into its analysis, the system 100 maintains its flexibility and effectiveness, such as in scenarios where traditional suspect identifiers may be limited, unavailable, or insufficient for identifying fraudulent patterns. This capability enhances the system 100's overall fraud detection abilities and allows it to adapt to a wider range of potential fraud scenarios.

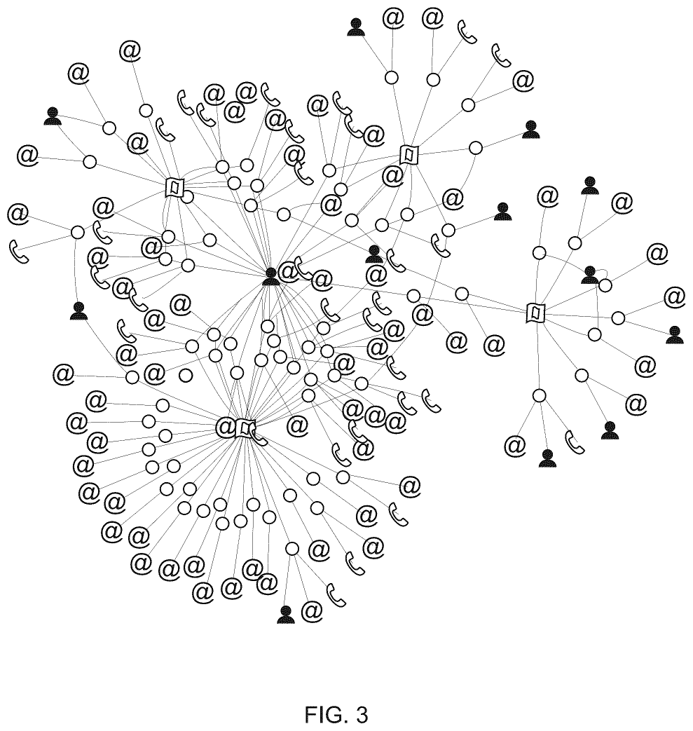

FIG. 3 illustrates an example of one of the plurality of groups 106a-c, providing a visual representation of how fraudsters attempt to bypass traditional fraud detection systems by using variations of suspect identifiers. In FIG. 3:
Tan circles represent individual incidents
“@” symbols represent unique email addresses
Phone symbols represent unique phone numbers
Map symbols represent unique addresses
Person symbols represent unique full names

The interconnected incidents in FIG. 3 illustrate a sophisticated fraud pattern where a single fraudster employs different combinations of identifiers for each order placed, effectively evading detection by conventional fraud prevention methods. This evasion technique involves strategically altering the provided identifier information with each new order, while occasionally reusing certain identifiers like names or addresses.

Traditional fraud detection approaches will fail to recognize the incidents shown in FIG. 3 as being related to a single fraudster, because such approaches typically focus on identifying repeated use of individual identifiers. For example, they might flag an email address or phone number that has been associated with multiple incidents. However, such methods are limited in their ability to detect more complex fraud schemes, such as that shown in FIG. 3, in which identifiers are varied across incidents.

In contrast, and as will be described in more detail below, embodiments of the present invention employ a more sophisticated approach. In particular, rather than solely examining the frequency of individual identifier usage, embodiments of the present invention compare each incoming incident to some or all connected fraud groups. This group-based analysis allows for the detection of subtle patterns and relationships between incidents that might otherwise go unnoticed. By analyzing the interconnections between various identifiers across multiple incidents within a group, embodiments of the present invention can identify potential fraud even when no single identifier is repeatedly used. This approach is particularly effective in detecting fraudulent activities where perpetrators deliberately vary their identifiers to avoid detection, as illustrated in FIG. 3.

The system 100 also includes a group analysis module 110. Once the plurality of groups 106a-c exists and the new incident 112 has been received or generated, the group analysis module 110 may process the new incident 112 by comparing the new incident 112 against the plurality of interrelated incidents 102 to determine whether the new incident 112 matches at least one group in the plurality of groups 106a-c (FIG. 2, operation 208). The comparing performed by the group analysis module 110 may include determining whether the new incident 112 has at least one suspect identifier that is similar to at least one suspect identifier in the plurality of groups 106a-c.

The group(s) that match the new incident 112 is/are referred to herein as the “fetched” group(s). The new incident 112 may be associated with (e.g., received from) an organization (e.g., a particular organization α) that is the same as or different from some or all of the organization(s) associated with some or all of the incidents in the fetched group(s). For example, the new incident 112 may be associated with (e.g., received from) an organization α that is different from some or all of the incidents in a fetched group. As this implies, a fetched group may include at least one incident that is associated with (e.g., was received from) an organization that differs from the organization α associated with the new incident 112 (e.g., the organization from which the new incident 112 was received). For example, each and every fetched group may include at least one incident associated with (e.g., received from) an organization different from organization α. For example, every one of the plurality of groups 106a-c may include at least one incident associated with (e.g., received from) an organization different from organization α.

In some embodiments, each of the plurality of groups 106a-c may contain only incidents associated with a single organization, with each group containing incidents associated with a different organization. For example, the first incident group 106a may contain only incidents associated with organization β, the second incident group 106b may contain only incidents associated with organization γ, and the third incident group 106c may contain only incidents associated with organization δ. In such embodiments, when the new incident 112 is received from organization α, the organization α may be different from the organizations associated with some or all of the plurality of groups 106a-c.

This organizational separation within groups may occur naturally due to the data collection practices of different organizations. Organizations typically maintain their own incident databases and fraud detection systems, collecting incidents that occur within their specific operational contexts. For example, a retail organization may collect incidents related to refund claims and chargebacks from their e-commerce platform, while a banking organization may collect incidents related to account access attempts and transaction disputes from their financial services. An insurance organization may collect incidents related to claims processing and policy applications from their insurance operations.

The incident grouping module 104 may receive incident data from these various organizations through the data acquisition methods disclosed herein, such as API integration, data import, or database synchronization. When processing incidents from different organizations, the incident grouping module 104 may initially form groups that reflect the organizational boundaries of the source data. This may result in organization-specific groups where incidents within each group share not only similar suspect identifiers but also common organizational attribution.

In such embodiments, the group analysis module 110 may compare the new incident 112 from organization α against groups that contain incidents from different organizations (β, γ, δ). This cross-organizational comparison may enable the system 100 to identify fraud patterns that span organizational boundaries while maintaining the organizational integrity of the existing groups. For example, if the new incident 112 from organization α contains suspect identifiers that are similar to suspect identifiers in incidents from organization β's group 106a, the group analysis module 110 may detect this cross-organizational connection and generate a fraud risk assessment 114 that incorporates insights from organization β's fraud patterns.

The group analysis module 110 may perform the comparison using various approaches, such as calculating similarity scores between suspect identifiers in the new incident 112 and suspect identifiers across multiple incidents within each group of the plurality of groups 106a-c. In some embodiments, the group analysis module 110 may determine similarity based on whether the calculated similarity score exceeds a predetermined threshold.

The group analysis module 110 may also analyze cross-incident relationships within each group to determine whether the new incident 112 exhibits similar relationship patterns with respect to suspect identifiers. For example, the group analysis module 110 may examine how suspect identifiers are distributed and connected across incidents within a particular group, and then assess whether the suspect identifiers in the new incident 112 follow comparable distribution or connection patterns. This analysis may enable the group analysis module 110 to identify connections even when individual suspect identifiers do not match exactly but demonstrate similar structural relationships within the context of fraudulent behavior patterns.

The group analysis module 110 may employ any of the similarity determination techniques disclosed herein to assess whether suspect identifiers in the new incident 112 correspond to suspect identifiers present within any of the groups 106a-c. In some cases, the group analysis module 110 may extract suspect identifiers from the new incident 112 and systematically compare these identifiers against suspect identifiers stored within each of the plurality of groups 106a-c. The comparison process may involve analyzing patterns of identifier variations within each group and determining whether suspect identifiers in the new incident 112 conform to the identified patterns, thereby enabling detection of sophisticated fraud schemes that use systematic obfuscation techniques.

The description herein refers to “similar” suspect identifiers. Embodiments of the present invention may identify any two or more suspect identifiers as being “similar” to each other in any of a variety of ways, such as any one or more of the following:
String Similarity Algorithms:
   Edit Distance: Algorithms like Levenshtein distance can calculate the number of single-character edits required to transform one identifier into another. A threshold can be set to determine similarity.
   Jaro-Winkler Distance: This algorithm is particularly effective for short strings like names or usernames, giving more weight to characters that match at the beginning of the string.
   Cosine Similarity: For longer text identifiers, this method can compare the similarity of two strings as vectors in multi-dimensional space.
Phonetic Matching:
   Soundex or Metaphone algorithms can convert names or words to a phonetic representation, allowing for matching of identifiers that sound similar but may be spelled differently.
Pattern Recognition:
   Regular Expressions: Can be used to identify patterns in identifiers, such as email addresses following a similar format (e.g., “basketballmike123@gmail.com” and “basketballmike124@gmail.com”).
   N-gram Analysis: Breaking identifiers into n-character substrings and comparing the overlap can identify similarities in structure.
Fuzzy Matching Algorithms:
   TF-IDF (Term Frequency-Inverse Document Frequency) with cosine similarity can be used for comparing longer text identifiers.
   Jaccard Similarity: Compares the similarity and diversity of sample sets, useful for comparing sets of identifiers associated with incidents.
Machine Learning Approaches:
Clustering Algorithms: Techniques like K-means or DBSCAN can group similar identifiers together based on various features.
   Word Embeddings: Techniques like Word2Vec or FastText can be used to convert identifiers into vector representations, allowing for similarity comparisons in vector space.
Domain-Specific Rules:
   For phone numbers, algorithms can normalize formats (removing spaces, dashes, etc.) before comparison.
   For addresses, parsing into components (street, city, state, zip) allows for more granular comparison and identification of slight variations.
Combination Approaches:
   Multiple methods can be combined using weighted scoring systems to provide a more robust similarity assessment.
   Ensemble methods can use multiple algorithms and aggregate their results to determine overall similarity.
Hashing Techniques:
   Locality-Sensitive Hashing (LSH) can be used to quickly identify potentially similar identifiers in large datasets.
Normalization Techniques:
   Case normalization, removal of special characters, and other preprocessing steps can be applied before comparison to focus on core similarities.
Semantic Analysis:
   For more complex identifiers, natural language processing techniques can be used to understand and compare the semantic meaning of identifiers.
Vector/Matrix Embeddings:
   Suspect identifiers may be transformed into numeric vector or matrix representations. These embeddings can capture complex relationships and similarities between identifiers that may not be apparent in their raw form.
Multi-Identifier Embeddings: The system 100 may create embeddings that represent combinations of multiple suspect identifiers (e.g., name and address) or even incorporate non-suspect identifier data (such as geo-temporal information). This allows for more nuanced similarity comparisons.
Vector Databases: The system 100 may store embeddings of suspect identifiers or combinations thereof in vector databases. These specialized databases enable rapid similarity searches across large datasets of incidents.

These methods may be implemented programmatically and applied systematically across large datasets of incidents, ensuring a consistent and objective assessment of identifier similarity. The specific thresholds for determining sufficient similarity may be set and adjusted based on the needs of the particular fraud detection context, allowing for fine-tuning of the system's sensitivity without introducing subjective human judgment into individual comparisons.

If vector representations are used, then when comparing a new incident to existing groups, the system 100 may compute similarity scores between the vector representations of the new incident's identifiers and those stored in the vector database. This allows for efficient detection of subtle connections that might indicate relationships to known fraud patterns. The system 100 may create vector/matrix representations that incorporate information from multiple incidents within a group. This enables comparison of new incidents against entire fraud patterns rather than individual identifiers. By employing vector/matrix representation techniques, the system 100 may perform sophisticated similarity comparisons that capture complex relationships between incidents, even when the raw suspect identifier data has been transformed. This approach ensures that the system 100 can detect potential fraud connections regardless of the form in which the data is represented.

In some embodiments, the group analysis module 110 may represent each group as a vector embedding and compare similarity between the vector embedding of the new incident 112 with the vector embedding of the group when comparing the new incident 112 against the plurality of interrelated incidents 102 to determine whether the new incident 112 matches at least one group in the plurality of groups 106a-c. The group-level vector embeddings may be computed by aggregating or combining vector representations of suspect identifiers from all incidents within each respective group, creating composite representations that capture the collective characteristics and patterns exhibited by the group as a whole. When the new incident 112 is received, the system 100 may convert the new incident 112 into a corresponding vector representation using the same embedding techniques applied to generate the group-level embeddings. The group analysis module 110 may then compute similarity scores between the new incident 112's vector representation and each group-level vector embedding using various distance metrics such as cosine similarity, Euclidean distance, or other vector similarity measures. This vector-based comparison approach may enable the system 100 to efficiently determine group matches by performing a relatively small number of vector similarity computations rather than comparing the new incident 112 against each individual incident within each group, while still capturing the complex patterns and relationships that characterize each group's fraud signature.

As yet another example, the system 100 may use one or more Large Language Models (LLMs) to detect similarity. For example, the system 100 may use LLMs in any of a variety of ways. As one example, the system 100 may use one or more LLMs to embed any of the data disclosed herein (e.g., suspect identifiers, incident data, and/or incident group data) into corresponding embeddings of any of the kinds disclosed herein. Such embeddings may represent data at any level of granularity. For example, the system 100 may use an LLM to generate one embedding per suspect identifier, or to create an embedding based on a plurality of suspect identifiers. Similarly, the system 100 may use an LLM to generate one embedding per incident, or to generate an embedding based on a plurality of incidents. As yet another example, the system 100 may use an LLM to generate one embedding per incident group, or to generate an embedding based on a plurality of incident groups.

The system 100 may use one or more LLMs to analyze the semantic meaning of any such data, such as suspect identifiers (or embeddings thereof), incident data (or embeddings thereof), or incident group data (or embeddings thereof). The system 100 may make such use of one or more LLMs for analysis, whether or not an LLM was used to generate the embeddings that are analyzed. For example, non-LLM techniques may be used to generate embeddings (e.g., of suspect identifiers, incident data, or incident group data), and the system 100 may then use one or more LLMs to analyze the resulting embeddings.

In any case, the use of LLMs for analysis allows for detection of similarities that go beyond surface-level text matching. This enables the system 100 to identify connections between incidents even when fraudsters use variations in wording or formatting. LLMs can consider the broader context of an incident, including non-suspect identifier data, to determine similarity. This allows the system 100 to perform more nuanced comparisons that take into account the full context of each incident. For example, LLMs can be trained to recognize complex patterns across multiple incidents, enabling the system 100 to identify sophisticated fraud schemes that may not be apparent through traditional analysis methods.

The system 100 may use one or more LLMs to generate high-dimensional embeddings (e.g., text embeddings) for suspect identifiers, incident data, and/or incident groups. These embeddings may then be used by the system 100 for efficient similarity comparisons using vector database techniques. As new incidents are processed, such LLMs can continuously refine their understanding of fraud patterns, allowing the system 100 to adapt to evolving fraud tactics over time.

Although the system 100 is designed to identify complex fraud patterns through sophisticated similarity comparisons, it is important to note that it may, additionally or alternatively, perform simple exact matching of suspect identifiers. For example, in some implementations, the system 100 may check for identical matches between suspect identifiers when comparing a new incident to existing groups. This approach, while basic, can still be effective in certain scenarios and may be used in combination with any of the more advanced comparison techniques disclosed herein. For example, when the system 100 determines whether a new incident matches any existing incidents, it may do so using only exact matching, only inexact matching (using any of the techniques disclosed herein), or both exact and inexact matching (such that the new incident is considered a match against an existing incident if the new incident is determined to match the existing incident either exactly or inexactly using any of the techniques disclosed herein).

The system 100 may update the stored plurality of interrelated incidents 102 to reflect that the new incident 112 is connected to the particular group, thereby enabling retrieval of the new incident 112 as part of the particular group (FIG. 2, operation 210). The system 100 may perform the update of operation 210 in response to the group analysis module 110 determining that the new incident 112 is similar to a particular group within the plurality of groups 106a-c. The plurality of groups 106a-c in the system 100 may be designed to dynamically update and evolve over time as new incidents are processed, enhancing the system 100's fraud detection capabilities by developing increasingly larger and more comprehensive groups as new incoming incidents are processed and connected to existing groups.

The updating process may involve modifying the connection data associated with the plurality of interrelated incidents 102 to establish linkages between the new incident 112 and the incidents already present within the matching group. The system 100 may create bidirectional references that allow the new incident 112 to be accessed through the particular group and enable the particular group to include the new incident 112 in subsequent analyses. This process may include adding the new incident 112's unique identifier to data structures representing the particular group, updating index structures that facilitate rapid retrieval of group members, and recalculating group-level metrics such as total incident count, diversity measures, or aggregate risk scores. The system 100 may also include temporal tracking of when the new incident 112 was added to the particular group, enabling the system 100 to maintain historical records of group evolution over time, and may store metadata about the connection strength between the new incident 112 and the particular group, such as similarity scores or confidence levels.

The system 100 may implement the updating process through various data structure modifications depending on the underlying storage architecture. For example, when using relational database systems, the system 100 may insert new records that establish foreign key relationships between the new incident 112 and the particular group. When using graph database structures, the system 100 may create new edges connecting the new incident 112 to existing nodes within the particular group. In vector database implementations, the system 100 may update proximity indices and clustering assignments to reflect the new incident 112's membership in the particular group. The updating process may also involve recalculating group-level embeddings when vector representations are used, incorporating the new incident 112's vector data into the collective representation of the particular group.

As part of operation 210, the system 100 may evaluate whether the addition of the new incident 112 creates connections between previously separate groups within the plurality of groups 106a-c. This evaluation may involve analyzing whether the new incident 112 shares suspect identifiers with incidents from multiple groups, potentially indicating that these groups should be merged into a larger connected group. For example, the new incident 112 may contain suspect identifiers that match or are similar to identifiers in both the first incident group 106a and the second incident group 106b, thereby creating bridging connections between these previously separate groups. The system 100 may quantify the strength of these bridging connections using various metrics, such as the number of shared suspect identifiers, the similarity scores between identifiers, or the total number of cross-group connections established by the new incident 112.

In some embodiments, updating the particular one of the plurality of groups 106a-c of connected incidents to include the new incident 112 may involve analyzing whether addition of the new incident 112 creates bridging connections to other groups in the plurality of groups 106a-c, and automatically initiating a merge process when the bridging connections exceed a predetermined connectivity threshold. When the calculated connectivity metrics exceed the predetermined connectivity threshold, the system 100 may automatically initiate a group merging process that combines the affected groups into a single, more comprehensive group. This merging process allows the system 100 to identify broader, more complex fraud patterns that may not have been apparent when the groups were separate.

To merge two or more previously separate groups, the system 100 may assess the strength of the connections between groups by analyzing the similarity of suspect identifiers and other relevant data points. Based on predefined thresholds or rules, the system 100 may determine whether the connections are strong enough to warrant merging the groups. If the merge criterion or criteria are met, the merging process may involve transferring all incidents from the separate groups into the newly merged group, updating all relevant data structures and indices, and recalculating group-level metrics and embeddings to reflect the expanded group composition. The system 100 may create a new group structure that combines the data from all groups involved in the merge, transfer all incidents from the previously separate groups into the newly created merged group structure, update the associations for all incidents now part of the merged group, and recalculate relevant metrics for the newly merged group, such as total number of incidents, diversity of unique identifiers, and overall fraud risk score.

In some cases, the system 100 may implement versioning mechanisms that preserve previous states of the plurality of groups 106a-c, allowing for rollback operations or historical analysis of group changes over time. This temporal information may be valuable for analyzing fraud pattern development and for implementing time-based analysis techniques. These larger and more comprehensive groups that develop over time provide a richer context for fraud analysis, allowing the system 100 to perform more accurate and nuanced fraud detection and decisioning using any of the techniques disclosed herein. As the groups grow and evolve, the system 100 may learn from these expanded datasets, potentially identifying new fraud patterns or refining its understanding of existing ones. This adaptive learning process continually improves the system 100's ability to detect and prevent fraud using any of the techniques disclosed herein.

The growing groups provide an increasingly robust historical context for analyzing new incidents. This historical perspective can be invaluable in identifying long-term fraud patterns or recurring fraudulent behaviors. By incorporating this dynamic group updating feature, the system 100 ensures that the system 100 remains effective and adaptive in the face of evolving fraud tactics. The continuously growing and merging groups provide an ever-improving foundation for all the fraud detection and decisioning processes described herein, allowing the system 100 to offer increasingly sophisticated and accurate fraud prevention over time.

The group analysis module 110 may generate and output a fraud risk assessment 114 for the new incident 112 based on the comparison performed in operation 210 of FIG. 2 (FIG. 2, operation 212). The general purpose of the fraud risk assessment 114 is to provide an analysis of how the new incident 112 relates to known fraud patterns in the incidents 102 and/or the plurality of groups 106a-c, enabling more informed decision-making regarding potential fraudulent activities. The fraud risk assessment 114 may contain a variety of information, such as any one or more of the following:
Similarity Score: A numerical value indicating the degree of similarity between the new incident 112 and the most closely matched group(s) from the plurality of groups 106a-c.
Matched Group Details: Information about the group(s) that the new incident 112 is most similar to, including the total number of incidents in the group, the total value of incidents, and the diversity of unique identifiers present.
Suspect Identifier Analysis: A breakdown of how the suspect identifiers in the new incident 112 compare to those in the matched group(s), highlighting any patterns or variations that may indicate fraudulent behavior.
Fraud Pattern Indicators: Specific flags or markers that indicate the presence of known fraud patterns within the matched group(s) and how they relate to the new incident 112.
Risk Probability: A calculated likelihood that the new incident 112 is part of a larger fraud scheme, based on its similarities to known fraudulent groups.
Anomaly Detection Results: An assessment of how the new incident 112 deviates from or aligns with the patterns observed in existing groups, potentially highlighting new fraud tactics.
Recommended Actions: Suggestions for further investigation or immediate actions based on the level of risk associated with the new incident 112.
Historical Context: Information on how similar incidents or groups have been handled in the past and their outcomes, providing context for decision-making.
Visualizations: Graphical representations of the connections between the new incident 112 and related incidents within the matched group(s), aiding in the understanding of complex fraud patterns.
Pattern Deviation Score: A metric indicating how closely suspect identifiers in the new incident 112 conform to established variation patterns in the particular group, generated through analysis of identifier variation patterns within the particular group to detect systematic obfuscation attempts. This score helps identify whether the new incident follows the same systematic identifier variation tactics used by fraudsters in the matched group.
Composite Risk Score: A calculated value that incorporates multiple risk factors from the matched group, including at least two of: a total count of incidents in the particular group, a diversity metric representing a ratio of unique suspect identifiers to total incidents in the particular group, or a temporal velocity metric representing a frequency of incident occurrence within the particular group over a predetermined time period. This composite approach provides a more comprehensive assessment of fraud risk by considering both the scale and characteristics of the fraud pattern.
Non-Fraudulent Incident Analysis: A comparison based on the count of non-fraudulent incidents connected to the particular group, which may provide insight into the legitimacy patterns within the matched group and inform the overall fraud risk calculation.

The fraud risk assessment 114 generated by the group analysis module 110 enables the system 100 to make more accurate and nuanced decisions about potential fraudulent activities. The composite risk score calculation allows the system 100 to consider multiple dimensions of fraud risk simultaneously, providing a more robust assessment than single-factor approaches. The pattern deviation score enables the system 100 to detect sophisticated obfuscation techniques where fraudsters systematically vary their identifiers according to specific patterns to avoid detection. Based on the fraud risk assessment 114, the system 100 may perform any of a variety of actions, such as any one or more of the following: labeling the new incident 112 as either legitimate or fraudulent (depending on the value of the fraud risk assessment 114), flagging the new incident 112 for further review, or stopping the new incident 112 from being processed normally. This approach allows the system 100 to adapt to evolving fraud tactics and improve overall fraud detection capabilities.

In relation to Example A, the group analysis module 110 may operate on an incoming incident (referred to below as “claim 43455”) by checking the suspect identifier(s) of the new incident 112 against those in the existing groups 106a-c. The group analysis module 110 may detect a very similar email address (either an identical match “basketballmike124@gmail.com” or a highly similar “basketballmike125@gmail.com”) and a very similar name that connects the new incident 112 to one of the existing groups 106a-c. For purposes of the following discussion, this existing group (also referred to as the “matching group” or “similar group”) may be group 106b.

The group analysis module 110 may determine whether new incident 112 is “similar” to one or more of the incidents in the existing group 106b in any of a variety of ways, such as by using any of the techniques described above. As another example, the group analysis module 110 may determine whether the suspect identifier(s) in the new incident 112 are similar to the suspect identifier(s) in the existing group 106b by computing a value of a similarity metric between the suspect IDs of the new incident 112 and the suspect IDs in the existing group 106b. The group analysis module 110 may then determine whether the computed value of the similarity metric satisfies a specific threshold, where this threshold determines whether the new incident 112 is considered sufficiently similar to be potentially part of the same fraud pattern.

When the group analysis module 110 determines that the new incident 112 is similar to the suspect IDs in the existing group 106b using any of the techniques disclosed herein, the group analysis module 110 may use information from the existing group 106b to inform the decision-making process regarding the potential fraudulence of the new incident 112. Such group information may include any one or more of the following: total count of incidents in the existing group 106b, total value of incidents in the existing group 106b, count of unique identifiers present in the existing group 106b, diversity metric representing a ratio of unique suspect identifiers to total incidents in the existing group 106b, temporal velocity metric representing a frequency of incident occurrence within the existing group 106b over a predetermined time period, and identifier variation patterns within the existing group 106b that may indicate systematic obfuscation attempts by fraudsters. This comprehensive analysis allows the group analysis module 110 to generate a more informed fraud risk assessment 114 that considers the broader context of the fraud pattern represented by the existing group 106b.

If the group analysis module 110 uses a similarity threshold to determine similarity, such a threshold may take any of a variety of forms, such as:
Simple Matching: The group analysis module 110 may link an incident to a group based on a single, exact match between one suspect identifier from the new incident 112 and any identifier from any incident within the existing group 106b. For example, if the email address “basketballmike124@gmail.com” in the new incident 112 matches identically with an email address in any incident within the existing group 106b, this could be sufficient to establish a link.
Complex Matching: The group analysis module 110 may employ more sophisticated criteria for linking, such as any one or more of the following:
   Multiple Identifier Pairs: Requiring matches between multiple pairs of identifiers from the new incident 112 and the existing group 106b.
   Cross-Incident Matching: Looking for matches between the new incident 112 and two or more different incidents within the existing group 106b, rather than just a single incident.
   Weighted Scoring: Assigning different weights to various types of identifier matches and calculating an overall similarity score.
   Combination of Exact and Similar Matches: Considering both identical matches and high-similarity matches across multiple identifiers.
   Pattern Conformity Analysis: Analyzing whether the suspect identifiers in the new incident 112 conform to established variation patterns within the existing group 106b, such as systematic changes in email addresses, phone numbers, or names that indicate coordinated obfuscation attempts.

The group analysis module 110 may employ various approaches to determine whether the new incident 112 matches existing groups within the plurality of groups 106a-c. The group analysis module 110 may allow for dynamic adjustment of linking thresholds based on characteristics of the target group, such as the total number of incidents within the group, the diversity of identifiers present across incidents in the group, and/or the overall risk level associated with the group's historical patterns. Rather than relying solely on exact identifier matches, the group analysis module 110 may identify specific patterns of identifier variations within a group and establish connections with incoming incidents that conform to these established patterns. This pattern-based approach may enable detection of systematic obfuscation attempts where fraudsters deliberately vary their identifiers according to predictable schemes, such as sequential numbering in email addresses or coordinated changes across multiple identifier types.

The group analysis module 110 may generate a pattern deviation score that quantifies how closely suspect identifiers in the new incident 112 conform to established variation patterns within a particular group from the plurality of groups 106a-c. This scoring mechanism may analyze identifier variation patterns within the target group to detect systematic obfuscation techniques and assess whether the new incident 112 exhibits similar obfuscation behaviors. The group analysis module 110 may consider various characteristics of existing groups, such as the presence of many differing identifiers across incidents, which may indicate fraudulent attempts to avoid detection through identifier variation. This comprehensive analysis may be incorporated into composite risk score calculations, providing a more nuanced fraud risk assessment 114 that accounts for both direct identifier similarities and behavioral pattern conformity. The flexible linking approach may balance accurate fraud detection capabilities with minimization of false positive rates, adapting to various fraud scenarios and tactics encountered across different industries and incident types.

Referring to FIG. 1, the system 100 may employ vector and matrix embeddings to represent various types of information, including suspect identifiers and incident data, enabling more sophisticated analysis capabilities. The group analysis module 110 may create group-level vector and matrix embeddings that combine data across multiple incidents within each of the plurality of groups 106a-c, providing compact representations of collective characteristics exhibited by incidents within each group. These group-level embeddings may encapsulate patterns of behavior, identifier usage, and other relevant features that emerge from analyzing multiple related incidents together, rather than examining incidents in isolation. The group-level embeddings may enable more efficient and comprehensive fraud detection by capturing subtle relationships and patterns that may not be apparent when analyzing individual incidents separately.

The system 100 may generate group-level embeddings through various approaches that combine information from multiple sources within each group. The group analysis module 110 may combine vector representations of suspect identifiers from all incidents within a particular group, creating composite representations that capture the full spectrum of identifier variations and patterns present within the group. The group-level embeddings may incorporate relevant non-suspect identifier data, such as temporal patterns of incident occurrence, geographical distributions of incidents within the group, transaction characteristics, and/or other contextual information that may be relevant for fraud detection purposes. The system 100 may encode additional group-specific information into the embeddings, such as group size metrics, total value calculations across incidents, diversity measurements representing the ratio of unique identifiers to total incidents, and/or other statistical properties that characterize the group's composition and behavior patterns.

With continued reference to FIG. 1, the system 100 may utilize group-level embeddings to perform efficient comparisons between existing groups and the new incident 112 through various computational approaches. When the group analysis module 110 processes the new incident 112, the system 100 may compare the new incident 112's vector representation against the group-level embeddings of existing groups within the plurality of groups 106a-c using vector algebra techniques and similarity calculations. The group-level embeddings may encapsulate patterns of fraudulent behavior across multiple incidents within each group, enabling the system 100 to reveal subtle connections to known fraud patterns that may not be apparent when comparing the new incident 112 to individual incidents separately. The group-level embedding approach may provide computational efficiency advantages by reducing the number of comparisons required, particularly as the plurality of groups 106a-c grow larger over time, since the system 100 may compare the new incident 112 to consolidated group representations rather than to each individual incident within each group.

Based on the group analysis described above, the group analysis module 110 may provide information to support a decision on whether the new incident 112 might be fraudulent or require a review for fraud. This decision may be informed by the collective behavior and patterns observed within the existing group 110, rather than just the characteristics of the individual new incident 112. The group analysis module 110 may employ various strategies to determine whether to identify the new incident 112 as fraudulent or as meriting a review for fraud. Examples of such strategies include any one or more of the following:
Incident Count Threshold: As suggested, the group analysis module 110 may flag a purchase for review if the new incident 112 is linked to a group with at least some predetermined number (e.g., 10) or more incidents. This approach helps identify potentially fraudulent activities associated with larger, more established fraud patterns.
Total Value Threshold: The group analysis module 110 may require that the new incident 112 be connected to a group of at least some predetermined number of (e.g., 3) incidents with a total price of at least some predetermined amount (e.g., $500) before flagging it. This method focuses on fraud patterns that involve significant financial impact.
Unique Identifier Ratio: The group analysis module 110 may calculate the ratio of unique identifiers to the number of incidents within a group. A high ratio could indicate a fraudster attempting to hide their identity by frequently changing information. A threshold may be set on this ratio to trigger fraud alerts.
Velocity Checks: The group analysis module 110 may analyze the frequency of incidents within a group over time. Unusually rapid occurrence of incidents may indicate fraudulent activity.
Geographic Dispersion: If incidents within a group are spread across an unusually wide geographic area, especially for typically local services, the group analysis module 110 may flag this as potentially fraudulent.
Pattern Recognition: The group analysis module 110 may identify specific patterns of identifier variations (e.g., email addresses with similar formats but different numbers) that are common in fraud attempts.
Pattern Deviation Analysis: The group analysis module 110 may analyze identifier variation patterns within the particular group to detect systematic obfuscation attempts and generate a pattern deviation score indicating how closely suspect identifiers in the new incident conform to established variation patterns in the particular group. A high pattern deviation score may indicate that the new incident follows the same systematic obfuscation tactics used by fraudsters in the matched group.
Value Distribution: The group analysis module 110 may flag unusual distributions of transaction values within a group (e.g., many transactions just below a typical fraud detection threshold) for review.
Time-of-Day Analysis: If incidents within a group consistently occur during unusual hours for the type of transaction, the group analysis module 110 may trigger a fraud alert.
Product Type Analysis: Certain types of products or services that are frequently targeted by fraudsters could lower the threshold for flagging an incident when present in a group.
Combination Rules: The group analysis module 110 may use a combination of any of the approaches described above, weighted appropriately, to create a more nuanced fraud risk score. For example, it might flag an incident if it is linked to a group with at least 5 incidents AND a total value over $300 OR a unique identifier ratio above a certain threshold.

By analyzing the new incident 112 in the context of the existing groups 106a-c in this way, the group analysis module 110 enables the system 100 to detect sophisticated fraud schemes that might be missed when evaluating incidents in isolation. This approach allows for more nuanced and effective fraud detection, particularly in cases where fraudsters attempt to evade traditional detection methods by varying their identifiers across multiple incidents.

The group analysis module 110 may generate the fraud risk assessment 114 based at least in part on cross-organization metrics computed from the fetched group, where these cross-organization metrics may provide insights into fraud patterns that span multiple organizational boundaries. These cross-organization metrics may comprise any one or more of the following: a cross-organization incident count, a cross-organization identifier-diversity metric, a cross-organization temporal velocity metric, and/or a pattern-deviation score derived from identifier-variation patterns across incidents contributed by at least two organizations. The cross-organization approach may enable the system 100 to identify sophisticated fraud schemes that operate across multiple organizations, which may not be detectable when analyzing incidents from individual organizations in isolation.

The cross-organization incident count may represent the total number of incidents within the fetched group that span multiple organizations, providing a measure of the breadth and scale of potential fraud activity across organizational boundaries. The group analysis module 110 may calculate this metric by identifying incidents within the fetched group that are associated with different organizations and aggregating the count across these organizational boundaries. In some cases, the cross-organization incident count may be weighted based on the number of distinct organizations represented within the fetched group, such that groups containing incidents from a larger number of organizations may receive higher cross-organization incident count scores. This metric may indicate the potential coordination or network effects of fraudulent activities that transcend individual organizational contexts, suggesting more sophisticated fraud operations that may warrant increased scrutiny.

Referring to FIG. 1, the cross-organization identifier-diversity metric may quantify the diversity of suspect identifiers present across incidents from multiple organizations within the fetched group. The group analysis module 110 may compute this metric by analyzing the ratio of unique suspect identifiers to total incidents across organizational boundaries, providing insights into whether fraudsters are using consistent identifiers across different organizations or employing varied obfuscation strategies. In some cases, the cross-organization identifier-diversity metric may be calculated separately for different types of suspect identifiers, such as email addresses, phone numbers, and physical addresses, enabling more granular analysis of identifier variation patterns across organizations. A high cross-organization identifier-diversity metric may indicate systematic attempts to avoid detection by varying identifiers across different organizational contexts, while a low metric may suggest the use of consistent identities across multiple organizations.

The cross-organization temporal velocity metric may measure the frequency and timing patterns of incident occurrence across multiple organizations within the fetched group over a predetermined time period. The group analysis module 110 may calculate this metric by analyzing the temporal distribution of incidents from different organizations, identifying patterns such as coordinated timing of fraudulent activities or rapid succession of incidents across organizational boundaries. In some cases, the cross-organization temporal velocity metric may incorporate time-zone adjustments and organizational operating hours to account for legitimate variations in incident timing across different organizations. This metric may reveal coordinated fraud campaigns that target multiple organizations simultaneously or in rapid succession, indicating organized fraud operations that may pose elevated risk levels.

With continued reference to FIG. 1, the pattern-deviation score derived from identifier-variation patterns across incidents contributed by at least two organizations may quantify how closely suspect identifiers in the new incident 112 conform to established variation patterns observed across multiple organizational contexts within the fetched group. The group analysis module 110 may analyze identifier variation patterns that span organizational boundaries, identifying systematic obfuscation techniques that fraudsters may employ consistently across different organizations. This cross-organization pattern analysis may reveal sophisticated fraud tactics where perpetrators maintain consistent obfuscation strategies while operating across multiple organizational environments. The pattern-deviation score may incorporate statistical measures of identifier similarity and variation across organizations, enabling detection of fraud schemes that adapt their tactics based on organizational characteristics while maintaining underlying behavioral patterns.

The group analysis module 110 may combine these cross-organization metrics using various weighting schemes and computational approaches to generate a comprehensive cross-organization fraud risk score as part of the fraud risk assessment 114. In some cases, the cross-organization metrics may be normalized and aggregated using machine learning algorithms that have been trained to recognize cross-organization fraud patterns based on historical data from multiple organizations. The system 100 may apply different weighting factors to each cross-organization metric based on the specific characteristics of the organizations represented in the fetched group, such as industry type, geographic location, or organizational size. The resulting cross-organization fraud risk assessment may provide insights into the likelihood that the new incident 112 is part of a broader fraud scheme that operates across multiple organizational boundaries, enabling more informed decision-making regarding fraud prevention and investigation priorities.

Embodiments of the system 100 may implement privacy-preserving mechanisms that enable cross-organizational fraud detection while maintaining data confidentiality between participating organizations. Referring to FIG. 1, the system 100 may enforce access constraints that prevent organizations from directly viewing incident-level data contributed by other organizations, while still enabling the group analysis module 110 to compute fraud risk assessments 114 using the collective data from multiple organizational sources. This approach may allow organizations to benefit from enhanced fraud detection capabilities through data collaboration without compromising sensitive business information or customer data privacy. In some embodiments, the group analysis module 110 may generate the fraud risk assessment 114 by enforcing a no-direct-access constraint under which incident-level data contributed by any organization in the particular group are not made directly accessible to other organizations contributing to the particular group, while permitting computation of the fraud risk assessment 114 using the incident-level data from multiple organizations.

The system 100 may implement the no-direct-access constraint through various technical approaches that maintain organizational privacy boundaries while enabling collective fraud analysis. In some cases, the incident grouping module 104 may maintain organizational attribution metadata for each incident within the incidents 102, tracking which organization contributed each incident while preventing cross-organizational data exposure through role-based access controls that restrict data visibility based on organizational identity. The system 100 may employ data encryption techniques where incident-level data from each organization is encrypted using organization-specific encryption keys, ensuring that only authorized systems may decrypt and process the data for fraud detection purposes. Additional privacy-preserving mechanisms may include data anonymization methods that remove or obfuscate organization-specific identifiers before cross-organizational analysis, and secure computation protocols that enable analysis without revealing underlying data to participating organizations.

With continued reference to FIG. 1, the group analysis module 110 may operate as a trusted intermediary that may access and process incident-level data from all organizations while maintaining the privacy boundaries between organizations. When the group analysis module 110 performs the comparison in operation 208 of method 200 (FIG. 2), the group analysis module 110 may analyze suspect identifiers and other incident characteristics across organizational boundaries without exposing the raw data to individual organizations. The system 100 may implement secure multi-party computation techniques that enable analysis of cross-organizational patterns without revealing underlying incident-level data to participating organizations, allowing the group analysis module 110 to compute similarity scores, pattern recognition metrics, and fraud risk assessments using encrypted or protected data representations. In some cases, the group analysis module 110 may employ federated learning approaches where machine learning models are trained on distributed organizational data without centralizing raw incident information from different organizations, enabling the system 100 to learn fraud patterns across organizational boundaries while preserving data locality and privacy.

The privacy-preserving mechanisms may enable the system 100 to generate fraud risk assessments 114 that leverage cross-organizational patterns while respecting data confidentiality requirements. For example, when the group analysis module 110 generates a fraud risk assessment 114 for a new incident 112 received from Organization A, the assessment may incorporate insights from incident patterns contributed by Organizations B and C without revealing the specific details of those incidents to Organization A. The fraud risk assessment 114 may include aggregate statistics and pattern indicators derived from multi-organizational analysis while omitting organization-specific incident details that could compromise data privacy, providing organizations with actionable fraud intelligence without exposing sensitive competitive information. The system 100 may provide different levels of detail in the fraud risk assessment 114 based on the privacy preferences and agreements between participating organizations, enabling customizable privacy protection while maintaining analytical utility.

In some embodiments, the system 100 may implement differential privacy techniques that add controlled noise to aggregate computations to prevent reverse-engineering of individual incident details from the fraud risk assessment 114, ensuring that individual incident details cannot be reverse-engineered from the fraud risk assessments 114 while maintaining the statistical utility of the cross-organizational analysis. The incident grouping module 104 may employ privacy-preserving clustering algorithms that may identify groups of connected incidents across organizational boundaries without exposing the linking suspect identifiers to participating organizations. These techniques may include homomorphic encryption methods that enable computations on encrypted data, secure aggregation protocols that combine organizational contributions without revealing individual inputs, and zero-knowledge proof systems that verify the validity of computations without exposing underlying data. The group analysis module 110 may compute cross-organization metrics from the particular group while maintaining organizational privacy boundaries, where the cross-organization metrics may comprise at least one of: a cross-organization incident count, a cross-organization identifier-diversity metric, or a cross-organization temporal velocity metric.

The system 100 may maintain audit trails and compliance mechanisms to ensure that the no-direct-access constraints are properly enforced throughout the fraud detection process. As shown in FIG. 2, when the method 200 updates the plurality of interrelated incidents 102 in operation 210 to reflect connections involving the new incident 112, the system 100 may record these updates in a manner that preserves organizational privacy boundaries while enabling future analysis. The system 100 may implement governance frameworks that define data sharing agreements, specify permitted uses of cross-organizational insights, and establish protocols for handling privacy violations or data breaches. In some cases, the system 100 may provide organizations with transparency reports that describe how their data has been used in aggregate computations without revealing specific details about other organizations'contributions, enabling accountability while maintaining the no-direct-access constraint.

The privacy-preserving approach may enhance the effectiveness of the group-based fraud detection capabilities described herein by enabling broader data collaboration while addressing the competitive and regulatory concerns that might otherwise prevent organizations from participating in collective fraud prevention efforts. Organizations may be more willing to contribute incident data to the system 100 when they have assurance that their sensitive information will not be directly accessible to competitors or other entities through the enforcement of the no-direct-access constraint. This increased participation may result in larger and more diverse datasets for the incident grouping module 104 to analyze, potentially improving the accuracy and comprehensiveness of the plurality of groups 106a-c and the resulting fraud risk assessments 114 generated by the group analysis module 110. The combination of privacy preservation and enhanced fraud detection capabilities may create a collaborative environment where organizations may share data for mutual benefit while maintaining competitive advantages and regulatory compliance.

The method 200 shown in FIG. 2 represents one example of a sequence of operations that may be performed by embodiments of the system 100, and the particular order of operations illustrated does not constitute a limitation of embodiments of the present invention. In some cases, the operations may be performed in different sequences while achieving the same technical objectives. For example, the method 200 may receive the new incident 112 in operation 204 before identifying the plurality of groups 106a-c in operation 206, as shown in FIG. 2. Alternatively, embodiments of the method 200 may identify the plurality of groups 106a-c in operation 206 before receiving the new incident 112 in operation 204. In some cases, operations 204 and 206 may be performed concurrently or in an overlapping manner, where the identification of groups may be ongoing while new incidents are continuously received and processed. The system 100 may adapt the sequence of operations based on various factors, such as computational efficiency requirements, data availability, real-time processing constraints, and/or the specific characteristics of the incident data being analyzed. Some embodiments may perform certain operations iteratively or recursively, where the identification of groups in operation 206 may be refined or updated as new incidents are received in operation 204, creating a dynamic feedback loop that enhances the accuracy of fraud detection over time.

The method 200 may also not include all operations shown in FIG. 2, depending on the specific implementation requirements and the current state of the system 100. For example, if the plurality of interrelated incidents 102 have already been stored with their associated connection data, the method 200 may omit operation 202. In such cases, the system 100 may begin with operation 204 or operation 206, utilizing the previously stored incident data and connection relationships. Similarly, if the new incident 112 has already been received by the system 100 through a separate process or previous execution of the method 200, operation 204 may be omitted, allowing the method 200 to proceed directly to the grouping and analysis operations.

In some embodiments, if a fraud risk assessment 114 is not desired or required for a particular implementation, operation 212 may be omitted from the method 200. This may occur in scenarios where the primary objective is to update the plurality of groups 106a-c with the new incident 112 without generating an immediate risk assessment, or where the risk assessment may be performed by a separate system or process. The modular nature of the method 200 allows for flexible implementation where certain operations may be bypassed based on the specific needs of the fraud detection application or the current processing context.

The system 100 may determine which operations to include or exclude based on various factors, such as the availability of pre-processed data, the specific fraud detection objectives, computational resource constraints, or integration requirements with other fraud detection systems. This flexibility enables embodiments of the present invention to be adapted to different operational environments and use cases while maintaining the core functionality of group-based fraud detection analysis. The incident grouping module 104 and group analysis module 110 may be configured to handle these variations in the method 200 execution, ensuring that the essential fraud detection capabilities are preserved regardless of which specific operations are performed.

Embodiments of the present invention may employ an approach to group-based fraud detection that focuses on dynamically fetching relevant incident clusters for risk assessment rather than maintaining static group assignments. Referring to FIG. 1, the system 100 may implement this approach through the incident grouping module 104 and group analysis module 110, which work together to maintain and analyze incident relationships in a flexible manner.

In some embodiments, the incident grouping module 104 may maintain a plurality of groups of connected incidents, where incidents within each group are connected based on similarities in suspect identifiers (FIG. 2, operation 202). This maintenance process may differ from static grouping approaches by allowing for more dynamic and contextual retrieval of related incidents. The system 100 may store the incidents 102 in a manner that preserves connection information while enabling flexible querying and retrieval based on similarity criteria. The incident grouping module 104 may organize the incidents 102 such that relationships between incidents are maintained through various data structures, including vector embeddings, graph representations, or hybrid approaches that combine multiple organizational methods.

When the group analysis module 110 receives a new incident 112 (FIG. 2, operation 204), the system 100 may initiate a fetching process that dynamically identifies and retrieves a group of incidents relevant to the new incident 112. This fetching process may involve comparing the new incident 112 against the plurality of groups of connected incidents to determine whether the new incident 112 is similar to at least one group in the plurality of groups of connected incidents. The comparison process may include determining whether the new incident 112 has at least one suspect identifier that is similar to at least one suspect identifier in the plurality of groups, using any of the similarity determination techniques disclosed herein.

The fetched group may contain at least two incidents which do not share the same suspect identifiers, distinguishing this approach from simple exact-match clustering methods. This characteristic allows the system 100 to capture complex fraud patterns where fraudsters may use completely different identifiers across incidents but still exhibit related behavioral patterns or connections through intermediate incidents. For example, the fetched group may include incidents that are connected through a chain of relationships, where incident A shares an email address with incident B, and incident B shares a phone number with incident C, even though incidents A and C share no common identifiers.

In some cases, the fetched group may contain at least one incident that was previously processed as a new incident by the same method, creating a dynamic learning environment where the system 100 builds upon previous analyses. This recursive processing capability allows the system 100 to develop increasingly sophisticated understanding of fraud patterns as more incidents are processed over time. The group analysis module 110 may track which incidents have been previously analyzed and incorporate this historical processing information into subsequent risk assessments.

The fetching process may employ one or more Large Language Models to enhance the precision and relevance of retrieved incident groups. In such embodiments, the system 100 may provide data from a larger group of connected incidents as input to a Large Language Model, which may then generate the fetched group as a subset of incidents from the larger group based on the provided data. This approach allows the Large Language Model to analyze semantic relationships and contextual patterns within the incident data that may not be captured through traditional similarity metrics. The Large Language Model may consider factors such as temporal patterns, geographical relationships, transaction characteristics, and subtle linguistic variations in suspect identifiers to determine the most relevant subset of incidents for analysis.

The fetched group may exhibit characteristics that reflect the nuanced nature of fraud pattern detection. In some cases, the fetched group may contain an incident D, while there exists an incident C that is not in the fetched group, such that the new incident 112 is more similar to incident C than the new incident 112 is to incident D. This apparent contradiction may occur when the fetching algorithm prioritizes contextual relevance or pattern completeness over simple pairwise similarity scores. For example, incident D may be included in the fetched group because it completes a fraud pattern or provides important contextual information, even though incident C may have higher individual similarity to the new incident 112.

The dynamic nature of the fetching process may result in groups that span traditional boundaries between previously established incident clusters. In some embodiments, the fetched group may consist of incidents that were previously present in at least two separate groups in the plurality of groups of connected incidents. This cross-group fetching capability allows the system 100 to identify broader fraud patterns that may not be apparent when analyzing incidents within traditional group boundaries. The group analysis module 110 may recognize that certain fraud schemes involve coordination across multiple previously identified groups, and the fetching process may retrieve incidents from these multiple groups to provide a more comprehensive view of the potential fraud pattern.

Based on the fetched group of incidents, the group analysis module 110 may generate a fraud risk assessment 114 for the new incident 112 (FIG. 2, operation 208). This risk assessment may leverage the collective information from the dynamically fetched group, providing insights that may not be available through static group analysis approaches. The fraud risk assessment 114 may incorporate analysis of the relationships between incidents in the fetched group, the diversity of suspect identifiers present, temporal and geographical patterns, and other factors that emerge from the specific combination of incidents retrieved for the new incident 112. The dynamic fetching approach may enable the system 100 to provide more contextually relevant and accurate fraud risk assessments by ensuring that each assessment is based on the most pertinent set of related incidents rather than predetermined group assignments.

Embodiments of the present invention may employ vector-based fraud detection techniques that utilize nearest neighbor incident clustering for enhanced pattern recognition and risk assessment. Referring to FIG. 1, the system 100 may implement this vector-based approach through the incident grouping module 104 and group analysis module 110, which work together to maintain and analyze incident relationships using high-dimensional vector representations in a vector embedding space. In some embodiments, the data may be grouped using vector embeddings based on suspect identifiers, in such a way that incidents with related suspect identifiers may have nearby vectors in the vector space. Instead of monitoring precise groups, embodiments of the system 100 may convert a new incident 112 to a vector representation based on that incident's suspect identifiers, then fetch a group of incidents from the databases based on nearby neighbors to the new incident 112's vector representation.

In some embodiments, the incident grouping module 104 may maintain a plurality of incidents 102 as vector representations, where the vector representations are based on suspect identifiers (FIG. 2, operation 202). This vector-based maintenance approach may organize incidents such that incidents with related suspect identifiers have nearby vectors in the vector space, enabling efficient similarity computations and pattern recognition operations. The system 100 may transform suspect identifiers into high-dimensional vector embeddings using various techniques, such as neural network-based embeddings, transformer models, or specialized fraud detection embedding algorithms. The vector space organization may allow the system 100 to capture semantic relationships between suspect identifiers that may not be apparent through traditional string matching or exact comparison methods. The vector query may employ some combination of k-nearest neighbor and/or range (radius) search techniques to identify relevant incidents within the vector embedding space.

When the group analysis module 110 receives a new incident 112 in vector representation form (FIG. 2, operation 204), the system 100 may initiate a vector-based fetching process that leverages the spatial relationships within the vector embedding space. The new incident 112 may be converted into a vector representation using the same embedding techniques applied to the plurality of incidents 102, ensuring consistency in the vector space representation. This conversion process may incorporate multiple suspect identifiers from the new incident 112 into a single composite vector representation, or may generate separate vectors for different types of suspect identifiers that are subsequently combined for analysis purposes. In more advanced embodiments, the vector query may adaptively home in on the nearest cluster by incorporating an initial promising neighbor and expanding toward the most relevant region of the space.

The system 100 may fetch a group of incidents from the plurality of incidents 102 based on nearby neighbors to the new incident 112's vector representation in the vector embedding space (FIG. 2, operation 206). This fetching process may employ various nearest neighbor search algorithms, such as k-nearest neighbor (k-NN) searches, range queries within a specified radius, or more sophisticated approximate nearest neighbor techniques for large-scale datasets. Advanced embodiments may include any one or more of the following techniques, in any combination: routing via a coarse quantizer and probing adjacent cells in an inverted file index (IVF), optionally with product quantization (PQ) and/or optimized product quantization (OPQ), such as multi-probe IVF; performing a best-first traversal over a proximity graph, such as Hierarchical Navigable Small World (HNSW), that expands from the initial neighbor; and/or probing predicted neighboring buckets in multi-probe locality-sensitive hashing (LSH). The vector-based fetching approach may enable the system 100 to identify incidents that are semantically related to the new incident 112 even when the suspect identifiers do not match exactly, capturing subtle variations and obfuscation attempts that fraudsters may employ to avoid detection.

The fetched group may contain at least two incidents which do not share the same suspect identifiers, demonstrating the advanced pattern recognition capabilities of the vector-based approach. This characteristic may allow the system 100 to identify complex fraud patterns where fraudsters use completely different suspect identifiers across incidents but maintain similar behavioral signatures that are captured in the vector representations. For example, the vector embeddings may encode patterns in how fraudsters systematically vary their identifiers, geographical preferences, temporal behaviors, or transaction characteristics, enabling the system 100 to group incidents based on these higher-level behavioral patterns rather than simple identifier matching. Search breadth, such as the number of probed clusters or graph expansion factor, may be adjusted dynamically based on intermediate distance or similarity scores until convergence criteria are met.

In some cases, the fetched group may contain at least one incident that was previously processed as a new incident by the same vector-based method, creating a dynamic learning environment where the system 100 builds upon previous vector-based analyses. This recursive processing capability may allow the vector representations to evolve and improve over time as more incidents are processed, with the vector embedding space becoming increasingly refined to capture fraud-specific patterns. The group analysis module 110 may track the processing history of incidents within the vector space and incorporate this temporal information into subsequent risk assessments. The adaptive nature of the vector query process may enable the system 100 to continuously refine the search parameters and convergence criteria based on the characteristics of the vector embedding space and the distribution of incidents within that space.

The fetching process may employ one or more Large Language Models to enhance the precision and contextual relevance of the vector-based incident retrieval. In such embodiments, the system 100 may provide vector representations from a larger group of connected incidents as input to a Large Language Model, which may then generate the fetched group as a subset of incidents from the larger group based on the provided vector representations. This approach may allow the Large Language Model to analyze complex relationships within the vector space that may not be captured through traditional distance metrics, considering factors such as vector clustering patterns, density distributions, and multi-dimensional relationships between incident vectors. The Large Language Model may also assist in determining optimal search breadth parameters and convergence criteria for the adaptive vector query process.

The vector-based fetching process may exhibit characteristics that reflect the sophisticated nature of high-dimensional pattern recognition. In some cases, the fetched group may contain an incident D, while there exists an incident C that is not in the fetched group, such that the new incident 112's vector representation is closer to incident C's vector representation than the new incident 112's vector representation is to incident D's vector representation. This apparent contradiction may occur when the fetching algorithm considers contextual factors beyond simple Euclidean distance, such as cluster density, pattern completeness, or fraud-specific similarity metrics that prioritize certain dimensions of the vector space over others. The adaptive search process may incorporate these contextual factors when determining which neighboring regions of the vector space to explore and when to terminate the search based on convergence criteria.

The dynamic nature of the vector-based fetching process may result in groups that transcend traditional clustering boundaries within the vector embedding space. In some embodiments, the fetched group may consist of incidents that were previously present in at least two separate groups of connected incidents based on vector proximity in the vector embedding space. This cross-cluster fetching capability may allow the system 100 to identify broader fraud patterns that span multiple vector space regions, potentially revealing coordinated fraud schemes that operate across different behavioral profiles or identifier variation strategies. The adaptive expansion toward the most relevant region of the space may enable the system 100 to discover these cross-cluster patterns by following proximity relationships that extend beyond initial cluster boundaries.

Based on the fetched group of incidents, the group analysis module 110 may generate a fraud risk assessment 114 for the new incident 112 (FIG. 2, operation 208). This vector-based risk assessment may leverage the spatial relationships and clustering patterns within the vector embedding space to provide nuanced fraud detection insights. The fraud risk assessment 114 may incorporate analysis of vector distances, cluster densities, neighborhood characteristics, and other vector space properties that emerge from the specific combination of incidents retrieved for the new incident 112. The vector-based approach may enable the system 100 to provide more mathematically rigorous and computationally efficient fraud risk assessments by utilizing the geometric properties of the vector embedding space to quantify fraud likelihood and pattern similarity. The adaptive search process may also provide additional metadata about the search convergence and cluster characteristics that may be incorporated into the fraud risk assessment 114.

Embodiments of the present invention may employ graph-based fraud detection techniques that utilize subgraph incident clustering for enhanced pattern recognition and relationship analysis. Referring to FIG. 1, the system 100 may implement this graph-based approach through the incident grouping module 104 and group analysis module 110, which work together to maintain and analyze incident relationships using graph structures where nodes represent incidents and edges represent connections based on similarities in suspect identifiers. In some embodiments, the data may be organized using graph structures where incidents are stored as nodes and relationships between incidents are represented as edges, enabling the system 100 to capture complex multi-hop relationships and network patterns that may not be apparent through other organizational methods. The graph structure may store data as a complex interconnected web rather than in distinct groups, allowing a graph query function to determine the subgraph of incidents to fetch as the relevant group for analysis.

In some embodiments, the incident grouping module 104 may maintain a plurality of incidents 102 in a graph structure, where connections across incidents are based on similarities in suspect identifiers (FIG. 2, operation 202). This graph-based maintenance approach may organize incidents such that related incidents are connected through edges that represent various types and strengths of relationships based on suspect identifier similarities. The system 100 may construct the graph structure using various graph database technologies or in-memory graph representations that enable efficient traversal and subgraph extraction operations. The graph organization may allow the system 100 to capture transitive relationships between incidents, where incident A may be connected to incident C through an intermediate incident B, even when incidents A and C share no direct suspect identifier similarities. The graph structure may support weighted edges that indicate the strength or confidence level of connections between incidents, enabling more nuanced analysis of relationship patterns. In some embodiments, the graph may contain incident-to-incident edges, while in other embodiments the edges may connect incidents to and from suspect identifiers, creating a bipartite graph structure that explicitly represents the relationships between incidents and the suspect identifiers that connect them.

When the group analysis module 110 receives a new incident 112 (FIG. 2, operation 204), the system 100 may initiate a graph-based fetching process that leverages the connectivity patterns within the graph structure. The new incident 112 may be compared against the plurality of incidents 102 in the graph structure to identify initial similarity matches based on suspect identifier comparisons. This comparison process may employ any of the similarity determination techniques disclosed herein, including exact matching, fuzzy matching, vector similarity computations, or machine learning-based similarity assessments. When similar incident or incidents are found, a graph query may be executed to fetch a subset of incidents where at least one of the similar incidents are included in that subset group. The graph-based approach may enable the system 100 to identify not only direct similarities but also indirect relationships through graph traversal algorithms that explore multi-hop connections between incidents.

The system 100 may fetch a group of incidents from the plurality of incidents 102 in the graph structure by computing a subgraph containing similar incidents based on links that connect them to other incidents (FIG. 2, operation 206). This fetching process may involve identifying one or more initial incidents that are similar to the new incident 112, then expanding outward from these initial incidents by following edges to connected incidents within the graph structure. The subgraph computation may employ various graph traversal algorithms, such as breadth-first search, depth-first search, or more sophisticated algorithms like random walks or community detection methods. The system 100 may return at least two or more incidents from the computed subgraph, ensuring that the fetched group captures the broader context of relationships surrounding the initially identified similar incidents. The subgraph extraction process may incorporate constraints such as maximum traversal depth, minimum edge weights, or specific relationship types to control the scope and relevance of the fetched group. The fetched subgraph may not be disjoint, meaning the subgraph may have links to other incidents that are not returned in the group fetch, which may occur due to limiting the number of hops in the graph query or other filtering criteria applied during the subgraph extraction process.

The fetched group may contain at least two incidents which do not share the same suspect identifiers, demonstrating the advanced relationship discovery capabilities of the graph-based approach. This characteristic may allow the system 100 to identify complex fraud networks where fraudsters operate through intermediary connections or use completely different suspect identifiers across incidents while maintaining network relationships through other participants or shared resources. For example, the graph structure may reveal that incident A shares an email address with incident B, incident B shares a phone number with incident C, and incident C shares an address with incident D, creating a connected subgraph even though incidents A and D share no direct suspect identifier similarities. The graph-based fetching approach may enable the system 100 to uncover these multi-hop fraud patterns that would be missed by approaches that only consider direct pairwise similarities. The interconnected web structure of the graph may allow the system 100 to discover relationships that span multiple degrees of separation, where the relevance of distant incidents may be determined by their position within the broader network topology rather than direct similarity to the new incident 112.

In some cases, the fetched group may contain at least one incident that was previously processed as a new incident by the same graph-based method, creating a dynamic learning environment where the system 100 builds upon previous graph-based analyses. This recursive processing capability may allow the graph structure to evolve and expand over time as more incidents are processed, with new edges being added and existing edge weights being updated based on accumulated evidence of relationships. The group analysis module 110 may track the processing history of incidents within the graph structure and incorporate this temporal information into subsequent subgraph computations and risk assessments. The dynamic nature of the graph structure may enable the system 100 to continuously refine the relationship patterns and improve the accuracy of subgraph extraction as more data becomes available. The graph query function may adapt its traversal strategies based on the evolving structure of the interconnected web, potentially discovering new pathways and connection patterns that emerge as the graph grows and becomes more densely connected.

The fetching process may employ one or more Large Language Models to enhance the precision and contextual relevance of the graph-based incident retrieval. In such embodiments, the system 100 may provide data from a larger subgraph of connected incidents as input to a Large Language Model, which may then generate the fetched group as a subset of incidents from the larger subgraph based on the provided data. This approach may allow the Large Language Model to analyze complex relationship patterns within the graph structure that may not be captured through traditional graph traversal algorithms, considering factors such as semantic relationships between suspect identifiers, temporal patterns in incident occurrence, or contextual information that spans multiple incidents. The Large Language Model may also assist in determining optimal subgraph boundaries and filtering criteria to ensure that the fetched group contains the most relevant incidents for fraud risk assessment purposes. The Large Language Model may analyze the interconnected web structure to identify which portions of the subgraph are most relevant to the new incident 112, even when those portions may not be directly connected through the shortest path algorithms typically used in graph traversal.

The graph-based fetching process may exhibit characteristics that reflect the sophisticated nature of network-based pattern recognition. In some cases, the fetched group may contain an incident D, while there exists an incident C that is not in the fetched group, such that the new incident 112 is more similar to incident C than the new incident 112 is to incident D. This apparent contradiction may occur when the fetching algorithm prioritizes network connectivity and relationship patterns over simple pairwise similarity scores, recognizing that incident D may provide valuable contextual information about the fraud network even though incident C may have higher individual similarity to the new incident 112. The subgraph computation process may incorporate various factors such as centrality measures, clustering coefficients, or community structure to determine which incidents should be included in the fetched group based on their role within the broader network pattern. The graph query function may determine that incident D's position within the interconnected web makes it more relevant for understanding the fraud pattern, even when incident C exhibits higher direct similarity to the new incident 112.

The dynamic nature of the graph-based fetching process may result in groups that span traditional boundaries between previously established incident clusters or communities within the graph structure. In some embodiments, the fetched group may consist of incidents that were previously present in at least two separate subgraphs in the graph structure, revealing broader fraud patterns that operate across multiple network communities or organizational boundaries. This cross-subgraph fetching capability may allow the system 100 to identify coordinated fraud schemes that involve multiple distinct groups or networks working in coordination, potentially uncovering sophisticated fraud operations that maintain separation between different components of their activities. The subgraph extraction process may follow weak ties or bridge connections that link otherwise separate communities within the graph structure, enabling the discovery of these cross-network fraud patterns. The interconnected web structure may contain pathways that connect disparate regions of the graph, allowing the graph query function to traverse these connections and identify relationships that span multiple previously distinct subgraphs or communities within the overall network topology.

Based on the fetched group of incidents, the group analysis module 110 may generate a fraud risk assessment 114 for the new incident 112 (FIG. 2, operation 208). This graph-based risk assessment may leverage the network structure and connectivity patterns within the fetched subgraph to provide insights into the new incident 112's position within potential fraud networks. The fraud risk assessment 114 may incorporate analysis of network metrics such as degree centrality, betweenness centrality, clustering coefficients, and path lengths that characterize the new incident 112's relationship to the broader fraud network. The graph-based approach may enable the system 100 to provide network-aware fraud risk assessments that consider not only the direct similarities between incidents but also the structural properties of the fraud network and the new incident 112's potential role within that network structure. The assessment may also consider the characteristics of the subgraph boundaries and the connections that extend beyond the fetched group, providing context about the new incident 112's position within the larger interconnected web of relationships.

Embodiments of the present invention include a variety of advantages and benefits over prior art systems, such as one or more of the following.

Embodiments of the present invention employ a novel approach by aggregating and analyzing incidents that are interconnected, rather than examining each incident in isolation. This group-based analysis allows for the detection of complex fraud patterns and anomalies that may not be apparent when viewing incidents individually. This approach significantly enhances the ability to uncover sophisticated fraud schemes that traditional methods might miss.

Embodiments of the present invention dynamically link incidents based on similarities in suspect identifiers, allowing for the formation and continuous updating of groups. This process enables embodiments of the present invention to adapt to evolving fraud tactics and capture relationships between incidents that may not be immediately obvious.

Embodiments of the present invention employ a range of methods to determine similarity between suspect identifiers, from simple exact matches to complex pattern recognition and machine learning approaches. This flexibility allows for the detection of fraud attempts even when perpetrators use variations of identifiers to avoid detection.

As new incidents are processed, the groups continuously grow and evolve, providing an ever-improving foundation for fraud detection. This dynamic updating feature allows embodiments of the present invention to learn from new data and refine its understanding of fraud patterns over time.

Embodiments of the present invention generate a detailed fraud risk assessment for each new incident, leveraging the collective information from grouped incidents. This assessment provides a multi-faceted evaluation of potential fraud, including similarity scores, matched group details, and specific fraud pattern indicators.

The system 100's design allows it to handle large volumes of incident data efficiently, making it suitable for industries with high transaction volumes. The group-based approach also allows for more efficient processing of new incidents by comparing them to existing groups rather than individual incidents.

While embodiments of the present invention provide advanced group-based fraud detection capabilities, its output may also be used in conjunction with traditional fraud determination methods that attempt to detect fraud based on isolated incidents that have not been collected into groups of connected incidents. Such an integrated approach allows for a more comprehensive and enriched fraud detection process. More specifically, traditional fraud detection methods typically analyze each transaction or incident independently, without considering connections to other incidents. These methods often employ predefined thresholds or rules to flag potentially fraudulent activities based on individual characteristics of a transaction. By combining the output from the system 100's group-based analysis with these traditional methods, organizations can create a more robust fraud detection strategy. This approach leverages both the advanced pattern recognition capabilities of the group-based system and the established methods of traditional fraud detection.

These innovative features collectively represent a significant advancement over traditional fraud detection methods. By shifting from individual incident analysis to a group-based, dynamically updating approach, embodiments of the present invention offer a more effective and adaptable solution for detecting and preventing fraudulent activities across various industries.

As used herein, an “organization” may refer to an entity that operates an independent data system, such as a merchant, bank, marketplace, or insurer. Organizations may contribute incident data to embodiments of the system 100 while maintaining separate operational boundaries and data governance requirements. Each organization may have distinct data formats, processing capabilities, and privacy requirements that influence how incident data is shared and analyzed within the fraud detection framework.

A “data-isolation constraint” may refer to a privacy-preserving mechanism that prevents raw records or plaintext suspect identifiers of one organization from being directly accessible to another organization, except within specific secure computing environments. In some embodiments, the data-isolation constraint may be enforced through trusted execution environments (TEEs) or privacy-preserving cryptographic techniques that prevent disclosure of plaintext values across organizational boundaries. This constraint may enable organizations to participate in collaborative fraud detection while maintaining confidentiality of sensitive business information and customer data.

Referring to FIG. 1, embodiments of the system 100 may operate in a federated cross-organization mode where incidents 102 are ingested by multiple organizations while respecting data-isolation constraints. In some cases, each organization may share raw incident data directly with a trusted execution environment for processing. Alternatively, organizations may pre-group incident data prior to sharing, or may maintain local incident nodes and intra-organization edges within their own systems. The incident grouping module 104 may include a federated linking module that establishes cross-organization edges and computes fetched groups while satisfying the data-isolation constraint, enabling the system 100 to identify fraud patterns that span multiple organizational boundaries without compromising data privacy.

Privacy-preserving linking techniques may enable the system 100 to link identifiers across organizations without revealing plaintext information. In some embodiments, these techniques may include trusted execution environments such as secure enclaves that perform tokenization, similarity computation, and edge-weighting operations on plaintext data only inside the enclave after remote attestation procedures. The system 100 may also employ private set intersection (PSI) or oblivious pseudorandom function (OPRF) protocols that produce link tokens from identifiers, allowing equality or similarity determinations without exposing the underlying identifiers. Additional privacy-preserving mechanisms may include HMAC-based or keyed locality-sensitive hashing (LSH) encodings generated with cryptographic keys provisioned only to secure enclaves, and secure aggregation techniques combined with differential privacy for aggregated statistics.

With continued reference to FIG. 1, federated graph construction may involve creating cross-organization edges when the privacy-preserving linking module indicates that identifiers match or are similar across organizations. The incident grouping module 104 may establish these cross-organization connections while maintaining the data-isolation constraint, enabling the formation of the plurality of groups 106a-c that span multiple organizational boundaries. This federated approach may allow the system 100 to identify complex fraud patterns that operate across different organizations while preserving the confidentiality of each organization's sensitive data.

In federated fetch and scoring operations, the group analysis module 110 may process a new incident 112 received by a first organization by computing similarity between the new incident 112 and the multi-organization dataset of interrelated incidents 102 that exists within the system 100. The fetched group may include incidents from multiple organizations, enabling cross-organizational fraud pattern detection. The fraud risk assessment 114 may be computed from composite metrics that include contributions from at least two organizations, such as cross-organization incident count, cross-organization identifier-diversity, and cross-organization temporal velocity metrics, as described elsewhere herein.

Enclave and multi-party computation (MPC) enforcement mechanisms may provide additional security guarantees for federated operations. In trusted execution environment embodiments, the first organization may remotely attest the enclave, with cryptographic keys being provisioned only after successful attestation procedures. Plaintext identifiers from participating organizations may be provided exclusively to the enclave, with outputs limited to group membership identifiers, aggregate statistics, and fraud scores. In multi-party computation embodiments, participating parties may exchange secret-shared or encrypted values such that no individual party may reconstruct another organization's plaintext data, ensuring that the data-isolation constraint is maintained throughout the computation process.

Access control and audit mechanisms may ensure that organizations can retrieve only results about their own incidents and privacy-preserving aggregates about other organizations. In some embodiments, all enclave and multi-party computation operations may be audited, including attestation measurements, cryptographic keys provisioned, and computational outputs. These audit trails may provide transparency and accountability while maintaining the data-isolation constraint, enabling organizations to verify that their data has been processed appropriately without gaining access to other organizations'sensitive information.

In some embodiments, incident relationships are represented in a graph structure comprising nodes and edges, where connections between incidents are based on similarities in suspect identifiers. The data need not be stored as static, disjoint “groups.” Instead, incidents may be maintained as a complex interconnected web, and a graph query function determines, at query time, the subgraph of incidents to fetch as the relevant group for analysis. The fetched subgraph need not be disjoint; it may contain links to additional incidents that are not returned due to constraints such as maximum hop count, edge-weight thresholds, or result-size limits. When a new incident is received, the system first checks for similarity to existing incidents based on at least one suspect identifier (using exact, fuzzy, or embedding-based similarity). Upon finding one or more similar incidents, the system executes a constrained graph query to fetch a subset that includes at least one of those similar incidents and their connected neighbors. In some embodiments, the graph may contain incident-to-incident edges; in other embodiments, edges link incidents to and from suspect identifiers (a bipartite representation), with incident-to-incident relationships derived by projection.

In some embodiments, incidents are encoded as vector embeddings based on suspect identifiers such that incidents with related identifiers are positioned nearby in the vector space. Rather than persisting precise group memberships, the system converts a new incident into a vector representation and fetches a group on demand by retrieving nearby neighbors from one or more embedding indexes. The vector query may use k-nearest neighbor and/or radius (range) search. In more advanced embodiments, the query adaptively homes in on the most relevant cluster by (i) routing via a coarse quantizer and probing adjacent cells in an inverted file index (IVF), optionally with PQ/OPQ (e.g., multi-probe IVF); (ii) performing a best-first traversal over a proximity graph (e.g., HNSW) expanding from an initial neighbor; and/or (iii) probing predicted neighboring buckets in multi-probe LSH. Search breadth (e.g., number of probed clusters or graph expansion factor) may be adjusted dynamically based on intermediate distances or similarity scores until convergence criteria are met.

In some embodiments, suspect identifiers further include drone-and AIDC-related identifiers and derived signals. Examples include FAA Remote ID, aircraft serial or tail number, controller/transmitter identifiers, beacon identifiers, and payload identifiers, as well as AIDC modalities such as barcode/QR payloads, RFID EPC/UIDs, NFC tags, and BLE beacon UUIDs. The system may additionally generate computer-vision embeddings from images or video of a drone and its payload (e.g., shape, livery, sensor layout, propeller count/size, paint patterns), and movement/trajectory embeddings learned from flight telemetry or vision-derived tracks (e.g., speed profiles, waypoint cadence, loiter patterns, ascent/descent signatures). These embeddings can be combined with traditional identifiers to support similarity comparisons and grouping. In some embodiments, the system infers an underlying controller or managing entity by linking multiple drones through shared controller identifiers, shared trajectory signatures, common launch/recovery locations, overlapping ground-station networks, or common firmware/configuration fingerprints. Such linkage may be used to form groups representing fleets operated by the same programmer, controller, or organization, even when individual drone identifiers vary across incidents.

In some embodiments, connection data is stored as a bipartite graph comprising incident nodes and suspect-identifier nodes. Edges carry identifier type, normalization details, and a relationship strength score. Incident-incident links used for grouping and analysis may be projected on demand from the bipartite structure (e.g., by aggregating edge weights across shared identifiers), enabling fine-grained control over how particular identifiers contribute to connectivity. In variants, hyperedges capture multi-identifier co-occurrence within an incident, and projections are computed with identifier-type-specific weights and attenuation factors.

In some embodiments, groups of incidents are computed by first constructing a weighted similarity graph over incident embeddings. Edges may be formed using k-nearest neighbors (k-NN) with weights given by cosine similarity or by a monotone kernel (e.g., exp(−d/σ)\ exp(−d∧sigma)exp(−d/σ)). To reduce hubness and spurious long-range ties, the system may use mutual k-NN or shared-nearest-neighbor (SNN) graphs. A community detection algorithm such as the Leiden method or Louvain modularity optimization is then applied to the weighted graph to produce incident communities. Resulting communities serve as groups for downstream comparison, refinement, and risk assessment.

In some embodiments, when processing a new incident, the system first identifies one or more similar incidents (via exact, fuzzy, or embedding-based similarity) and then expands from those seed incidents to fetch a local group (e.g., by neighborhood expansion in a graph, radius search in an embedding index, or constrained subgraph extraction). This seed-and-expand approach retrieves a contextually relevant cluster even when the new incident does not yet meet global grouping thresholds, providing a focused basis for risk scoring and explanation.

In some embodiments, each stored relationship (e.g., incident↔identifier edge or incident↔incident link) carries a strength score together with provenance metadata, including algorithm/version, timestamp, data source, jurisdiction or policy context, and preprocessing/normalization steps. The system may maintain versioned relationship records to support historical audits, replay under prior scoring logic, and comparative evaluation of refinement strategies. Scores can be recalculated when identifiers are re-normalized or when model parameters change, with deltas recorded for auditability.

In some embodiments, the system supports a verification stage in which a candidate group is reviewed and marked as verified by either (i) a human analyst or (ii) an automated verifier such as a Large Language Model (LLM) operating under policy constraints. A verified group is a group whose current membership and summary metadata (e.g., representative identifiers, variation patterns, velocity/diversity metrics) have been explicitly validated. Upon verification, the group enters a locked state for matching purposes: incoming-incident similarity uses the verified representation of the group, while subsequent structural changes are not immediately applied to the locked state.

In some embodiments, any post-verification modifications (e.g., adding/removing incidents, merging/splitting groups, edge-weight re-scores) are routed to a recommendation queue rather than being applied directly. Recommendations may originate from incremental algorithms (e.g., neighborhood expansion), refinement logic, or verifier suggestions. Each recommendation includes: (i) the proposed change, (ii) supporting evidence (similarity scores, identifiers, provenance), and (iii) an estimated impact on risk metrics. Recommendations may be batched and presented for approval by a human or an LLM verifier; only approved recommendations are committed, updating the group's verified version.

In some embodiments, a verified group maintains immutable versions. Incoming-incident matching references the latest verified version (e.g., group_id@vN). Pending recommendations may generate candidate drafts (e.g., group_id@vN+draft), which are not used for production similarity until verified. This gating ensures that high-velocity updates do not destabilize decisioning and that similarity outcomes remain reproducible.

In some embodiments, verification is governed by policies that define when human approval is required versus when an LLM verifier may auto-approve. Policies may depend on change magnitude (e.g., merge of large groups), risk sensitivity (e.g., regulated domains), or evidence strength (aggregate similarity, identifier trust levels, temporal/geographic coherence). The system may compute a verification confidence score that combines evidence quality and verifier reliability; only changes exceeding a threshold are auto-approved, otherwise they are routed to human review. In some embodiments, an LLM verifier evaluates candidate changes using structured context (e.g., top-k supporting incidents, normalization details, similarity distributions, refinement hints, and prior decisions) and emits an approve/reject decision together with a concise rationale referencing specific evidence. In some embodiments, human reviewers are presented with an evidence pack (proposed diff, key identifiers with weights, exemplar incidents, similarity plots, and predicted impact on risk scoring) and may accept, modify, or reject recommendations; reviewer notes are stored as verification artifacts.

In some embodiments, each verification event (human or LLM) produces an append-only audit record containing inputs, decision, rationale, and the resulting group version. The system supports rollback to a prior verified version (e.g., if later evidence invalidates a change) and replay of incoming-incident matching under historical versions for compliance or dispute resolution.

In some embodiments, the system uses graph-based retrieval-augmented generation (GraphRAG) to produce explanations and recommended actions. Given a query (e.g., an incoming incident or a candidate merge/split), the system retrieves a policy-filtered subgraph via neighborhood expansion or community lookup (with hop limits, identifier-type filters, and edge-weight thresholds), then serializes it into a structured context pack (node/edge tables with strengths, timestamps, provenance, and exemplar incidents). A language model consumes only this context pack to generate a traceable rationale that cites specific nodes/edges and versioned groups (e.g., group_id@vN).

In some embodiments, the system maintains provenance and tamper-evident logs for all group operations and risk outputs. Each mutation to a group (e.g., creation, merge, split, refinement, membership addition/removal) may generate an append-only event record containing at least: a unique event identifier, timestamp, actor/process identity, pre-and post-state digests of the affected group, and the decision rationale or rule/model that triggered the change. Event records may be chained by including a cryptographic hash of the prior record, producing a hash chain that renders the audit trail tamper-evident. The system may also periodically snapshot full group state (including salient edges, scores, and embeddings) and store a signed digest of the snapshot to an external or write-once medium to enable independent verification.

In some embodiments, the system implements a human/LLM verification workflow for group quality control. Groups may exist in multiple states, such as “advisory,” “candidate,” and “verified.” Candidate groups may be accompanied by an LLM-generated summary of salient evidence (top linking identifiers, strongest edges, temporal/geo signals) and recommended actions. A human analyst may review and either (i) confirm the group as verified, (ii) request edits (e.g., remove over-connected nodes), or (iii) reject the grouping. Until verified, groups may be used for soft actions (e.g., triage, scoring features) but not for hard actions (e.g., automatic declines) unless additional policy thresholds are met. The workflow may also permit LLM-assisted proposals for adding/removing incidents, with such changes queued as recommendations pending human approval.

In some embodiments, the system includes over-connection controls to mitigate hubness and spurious links. Controls may include: (i) detection of high-degree hubs and capping their contribution to connectivity; (ii) mutual-kNN or shared-nearest-neighbor (SNN) requirements before establishing edges; (iii) per-identifier “always-link” and “never-link” lists with configurable precedence; (iv) edge reweighting based on identifier rarity, entropy, or historical false-positive rates; and (v) refinement passes that temporarily remove suspected hub identifiers, compute subgroup cohesion, and only reinstate connections if inter-subgroup similarity exceeds a threshold. These controls may be applied both during initial group formation and as a periodic hygiene process.

The present disclosure provides a method for use with a plurality of interrelated incidents, the method performed by at least one computer processor executing computer program instructions stored on at least one non-transitory computer-readable medium. The method includes storing the plurality of interrelated incidents with associated connection data indicating relationships between incidents based on similarities in suspect identifiers, wherein the plurality of interrelated incidents are associated with a plurality of organizations. The method further includes receiving a new incident from an organization α, and identifying, based on the plurality of interrelated incidents and connection data, a plurality of groups of connected incidents from the plurality of interrelated incidents, wherein each group in the plurality of groups comprises a corresponding plurality of incidents connected based on similarities in suspect identifiers. The method also includes comparing the new incident against the plurality of interrelated incidents to determine whether the new incident matches at least one group in the plurality of groups, wherein each of the plurality of groups includes at least one incident associated with an organization different from the organization α, wherein the comparing comprises determining whether the new incident has at least one suspect identifier that is similar to at least one suspect identifier in the plurality of groups. In response to determining that the new incident matches a particular group in the plurality of groups of connected incidents, the method includes storing an association between the new incident and the particular group, thereby enabling retrieval of a group that includes the new incident together with at least one incident from the particular group. The method further includes generating a fraud risk assessment for the new incident based on the comparison, comprising, in response to determining that the new incident is determined to be similar to the particular group, generating the fraud risk assessment for the new incident based on information from the particular group.

In some embodiments, updating the plurality of groups of connected incidents may include merging at least two groups in the plurality of groups into a merged group. Maintaining the plurality of groups of connected incidents may include creating vector embeddings based on suspect identifiers and determining connections based on vector similarity calculations.

In other embodiments, comparing the new incident against the plurality of groups of connected incidents may include calculating a similarity score between suspect identifiers in the new incident and suspect identifiers across multiple incidents within each group, and determining similarity based on whether the similarity score exceeds a predetermined threshold. The comparing may also include identifying patterns of identifier variations within each group and determining whether suspect identifiers in the new incident conform to the identified patterns, or analyzing cross-incident relationships within each group to determine whether the new incident exhibits similar relationship patterns with respect to suspect identifiers.

In further embodiments, updating the particular one of the plurality of groups of connected incidents to include the new incident may include dynamically adjusting similarity thresholds for the particular group based on statistical properties of suspect identifiers within the updated group.

In some cases, identifying the plurality of groups of connected incidents may include refining a selected group of the plurality of groups to create a refined subset group by evaluating whether the selected group is over-connected due to one or more problematic suspect identifiers that create spurious connections between incidents, breaking connections associated with the one or more problematic suspect identifiers to split the selected group into two or more candidate subgroups, verifying at least one of the candidate subgroups as a refined subgroup using a verification process, and designating the at least one refined subgroup as part of the plurality of groups, wherein the comparing includes comparing the new incident against the plurality of groups including the at least one refined subgroup. The verification process may include using a Large Language Model to compute similarity scores between the candidate subgroups. Refining the selected group may further include recursively applying the evaluation, breaking, verification, and designation steps to at least one of the candidate subgroups.

In additional embodiments, storing the plurality of interrelated incidents may include storing the plurality of interrelated incidents as vector embeddings, or storing the connection data as links in a graph database structure, wherein each incident is represented as a node and each relationship between incidents based on similarities in suspect identifiers is represented as an edge connecting corresponding nodes. The connection data may include links between incidents, each link containing a score indicating a strength of relationship between connected incidents, and identifying the plurality of groups of connected incidents may include computing the plurality of groups based on the scores contained in the links. When vector embeddings are used, identifying the plurality of groups of connected incidents may include computing the plurality of groups based on proximity of the vectors in the vector space.

The present disclosure also provides a system for use with a plurality of interrelated incidents, the system comprising at least one non-transitory computer-readable medium having computer program instructions stored thereon, the computer program instructions being executable by at least one computer processor to perform the method described above, including all the various embodiments and variations thereof.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention are necessarily rooted in computer technology due to several key aspects of its design and implementation. For example, embodiments of the present invention are designed to handle and analyze vast amounts of incident data, far beyond what would be feasible for human processing. This capability is inherently tied to computer technology, as it requires significant computational power to efficiently process and analyze millions (or even thousands) of incidents and their associated identifiers. As another example, embodiments of the present invention employ a range of methods to determine similarity between suspect identifiers, from simple exact matches to complex pattern recognition. These assessments often involve advanced string comparison algorithms and machine learning techniques that are inherently computational. Furthermore, the ability of embodiments of the present invention to continuously learn and adapt their fraud detection capabilities based on new incident data is a hallmark of machine learning and artificial intelligence technologies. As yet another example, embodiments of the present invention are designed to integrate with various digital platforms and systems, such as e-commerce websites, banking software, and point-of-sale systems, to receive and process incident data in real-time. Such integration is inherently tied to computer and network technologies.

Embodiments of the present invention also transform data into a different state or thing in a variety of ways. For example, embodiments of the present invention take individual incident reports as input and transforms them into interconnected groups based on similarities in suspect identifiers. This process converts isolated data points into a structured network of related incidents, representing a significant transformation of the original data. Embodiments of the present invention may also extract and standardize suspect identifiers from the raw text of incident reports. This process transforms unstructured textual data into structured, comparable data points, enabling efficient analysis and linking of incidents. As another example, embodiments of the present invention may also transform the grouped incident data into comprehensive fraud risk assessments for new incidents. This process converts raw data and group information into actionable insights, representing a practical application of the transformed data. These and other transformations demonstrate that embodiments of the present invention go beyond mere data gathering or analysis. Embodiments of the present invention fundamentally alter the state of the input data, creating new forms of data and insights that have practical applications in fraud detection and prevention.

Embodiments of the present invention are directed to a practical application that goes beyond merely an abstract idea. For example, by employing a group-based analysis framework, embodiments of the present invention significantly enhance the ability to identify complex fraud patterns that traditional methods often miss. This practical application directly translates to more accurate fraud detection in real-world scenarios, potentially saving businesses and consumers from substantial financial losses. The ability of embodiments of the present invention to process and analyze vast amounts of incident data in real-time allows for immediate fraud risk assessments. This practical application enables businesses to take proactive measures to prevent fraudulent activities before they result in financial losses or other damages. The ability of embodiments of the present invention to dynamically link and update groups of incidents allows it to continuously evolve its fraud detection strategies. This practical application ensures that the system remains effective against new and emerging fraud tactics, providing ongoing protection in an ever-changing fraud landscape.

Embodiments of the present invention solve a significant technical problem in the field of fraud detection using an innovative technical solution. For example, embodiments of the present invention address the limitations of traditional fraud detection systems that struggle to identify complex, evolving fraud patterns in large-scale digital environments. One technical problem solved by embodiments of the present invention is the inability of conventional fraud detection systems to effectively identify and prevent sophisticated fraud schemes that involve multiple interconnected incidents and evolving tactics. Embodiments of the present invention provide a technical solution to this problem through their innovative group-based analysis framework and dynamic data processing capabilities: For example, embodiments of the present invention transform individual incident data into interconnected groups based on similarities in suspect identifiers. This approach enables the detection of complex fraud patterns that are not visible when analyzing incidents in isolation. Embodiments of the present invention also continuously update and merge incident groups as new data is processed. This dynamic approach allows the system to adapt to evolving fraud tactics in real-time. By implementing these technical solutions, embodiments of the present invention overcome the limitations of traditional fraud detection systems by providing a more comprehensive, efficient, and adaptable approach to identifying and preventing fraudulent activities in complex digital environments.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method for use with a plurality of interrelated incidents, the method performed by at least one computer processor executing computer program instructions stored on at least one non-transitory computer-readable medium, the method comprising:
(A) storing the plurality of interrelated incidents with associated connection data indicating relationships between incidents based on similarities in suspect identifiers, wherein the plurality of interrelated incidents are associated with a plurality of organizations;
(B) receiving a new incident from an organization α;
(C) identifying, based on the plurality of interrelated incidents and connection data, a plurality of groups of connected incidents from the plurality of interrelated incidents, wherein each group in the plurality of groups comprises a corresponding plurality of incidents connected based on similarities in suspect identifiers
(D) comparing the new incident against the plurality of interrelated incidents to determine whether the new incident matches at least one group in the plurality of groups, wherein each of the plurality of groups includes at least one incident associated with an organization different from the organization α, wherein the comparing comprises determining whether the new incident has at least one suspect identifier that is similar to at least one suspect identifier in the plurality of groups;
(E) in response to determining that the new incident matches a particular group in the plurality of groups of connected incidents, storing an association between the new incident and the particular group, thereby enabling retrieval of a group that includes the new incident together with at least one incident from the particular group; and
(F) generating a fraud risk assessment for the new incident based on the comparison, comprising, in response to determining that the new incident is determined to be similar to the particular group, generating the fraud risk assessment for the new incident based on information from the particular group.

2. The method of claim 1, wherein updating the plurality of groups of connected incidents comprises merging at least two groups in the plurality of groups into a merged group.

3. The method of claim 1, wherein maintaining the plurality of groups of connected incidents comprises
creating vector embeddings based on suspect identifiers; and
determining connections based on vector similarity calculations.

4. The method of claim 1, wherein comparing the new incident against the plurality of groups of connected incidents comprises calculating a similarity score between suspect identifiers in the new incident and suspect identifiers across multiple incidents within each group, and determining similarity based on whether the similarity score exceeds a predetermined threshold.

5. The method of claim 1, wherein comparing the new incident against the plurality of groups of connected incidents comprises identifying patterns of identifier variations within each group and determining whether suspect identifiers in the new incident conform to the identified patterns.

6. The method of claim 1, wherein comparing the new incident against the plurality of groups of connected incidents comprises analyzing cross-incident relationships within each group to determine whether the new incident exhibits similar relationship patterns with respect to suspect identifiers.

7. The method of claim 1, wherein updating the particular one of the plurality of groups of connected incidents to include the new incident comprises dynamically adjusting similarity thresholds for the particular group based on statistical properties of suspect identifiers within the updated group.

8. The method of claim 1, wherein identifying the plurality of groups of connected incidents in step (C) comprises refining a selected group of the plurality of groups to create a refined subset group by:
(C)(1)evaluating whether the selected group is over-connected due to one or more problematic suspect identifiers that create spurious connections between incidents;
(C)(2)breaking connections associated with the one or more problematic suspect identifiers to split the selected group into two or more candidate subgroups;
(C)(3)verifying at least one of the candidate subgroups as a refined subgroup using a verification process; and
(C)(4)designating the at least one refined subgroup as part of the plurality of groups;
wherein (D) comprises comparing the new incident against the plurality of groups including the at least one refined subgroup.

9. The method of claim 8, wherein the verification process in step (C)(3) comprises using a Large Language Model to compute similarity scores between the candidate subgroups.

10. The method of claim 8, wherein refining the selected group further comprises recursively applying steps (C)(1), (C)(2), (C)(3), and (C)(4) to at least one of the candidate subgroups.

11. The method of claim 1, wherein storing the plurality of interrelated incidents comprises storing the plurality of interrelated incidents as vector embeddings.

12. The method of claim 1, wherein storing the plurality of interrelated incidents comprises storing the connection data as links in a graph database structure, wherein each incident is represented as a node and each relationship between incidents based on similarities in suspect identifiers is represented as an edge connecting corresponding nodes.

13. The method of claim 1, wherein the connection data comprises links between incidents, each link containing a score indicating a strength of relationship between connected incidents, and wherein identifying the plurality of groups of connected incidents comprises computing the plurality of groups based on the scores contained in the links.

14. The method of claim 11, wherein identifying the plurality of groups of connected incidents comprises computing the plurality of groups based on proximity of the vectors in the vector space.

15. A system for use with a plurality of interrelated incidents, the system comprising at least one non-transitory computer-readable medium having computer program instructions stored thereon, the computer program instructions being executable by at least one computer processor to perform a method, the method comprising:
(A) storing the plurality of interrelated incidents with associated connection data indicating relationships between incidents based on similarities in suspect identifiers, wherein the plurality of interrelated incidents are associated with a plurality of organizations;
(B) receiving a new incident from an organization α;
(C) identifying, based on the plurality of interrelated incidents and connection data, a plurality of groups of connected incidents from the plurality of interrelated incidents, wherein each group in the plurality of groups comprises a corresponding plurality of incidents connected based on similarities in suspect identifiers
(D) comparing the new incident against the plurality of interrelated incidents to determine whether the new incident matches at least one group in the plurality of groups, wherein each of the plurality of groups includes at least one incident associated with an organization different from the organization α, wherein the comparing comprises determining whether the new incident has at least one suspect identifier that is similar to at least one suspect identifier in the plurality of groups;
(E) in response to determining that the new incident matches a particular group in the plurality of groups of connected incidents, storing an association between the new incident and the particular group, thereby enabling retrieval of a group that includes the new incident together with at least one incident from the particular group; and
(F) generating a fraud risk assessment for the new incident based on the comparison, comprising, in response to determining that the new incident is determined to be similar to the particular group, generating the fraud risk assessment for the new incident based on information from the particular group.

16. The system of claim 15, wherein updating the plurality of groups of connected incidents comprises merging at least two groups in the plurality of groups into a merged group.

17. The system of claim 15, wherein maintaining the plurality of groups of connected incidents comprises
creating vector embeddings based on suspect identifiers; and
determining connections based on vector similarity calculations.

18. The system of claim 15, wherein comparing the new incident against the plurality of groups of connected incidents comprises calculating a similarity score between suspect identifiers in the new incident and suspect identifiers across multiple incidents within each group, and determining similarity based on whether the similarity score exceeds a predetermined threshold.

19. The system of claim 15, wherein identifying the plurality of groups of connected incidents in step (C) comprises refining a selected group of the plurality of groups to create a refined subset group by:
(C)(1)evaluating whether the selected group is over-connected due to one or more problematic suspect identifiers that create spurious connections between incidents;
(C)(2)breaking connections associated with the one or more problematic suspect identifiers to split the selected group into two or more candidate subgroups;
(C)(3)verifying at least one of the candidate subgroups as a refined subgroup using a verification process; and
(C)(4)designating the at least one refined subgroup as part of the plurality of groups;
wherein (D) comprises comparing the new incident against the plurality of groups including the at least one refined subgroup.

20. The system of claim 15, wherein storing the plurality of interrelated incidents comprises storing the connection data as links in a graph database structure, wherein each incident is represented as a node and each relationship between incidents based on similarities in suspect identifiers is represented as an edge connecting corresponding nodes.
